(19) United States
(12) Patent Application Publication
(10) Pub. No.: US 2011/0045598 A1
(43) Pub. Date: Feb. 24, 2011

(54) METHODS FOR DETERMINING ENANTIOMERIC PURITY WITH IMPROVED CHIRAL SELECTORS

(75) Inventors: Kenneth W. Busch, Waco, TX (US); Selorm Modzabi, Waco, TX (US); Marianna Busch, Waco, TX (US)

Correspondence Address: JACKSON WALKER LLP, 901 MAIN STREET, SUITE 6000, DALLAS, TX, 75202-3797, US

(73) Assignee: Baylor University

(21) Appl. No.: 12/738,245

(22) PCT Filed: Oct. 17, 2008
(86) PCT No.: PCT/US08/11858

§ 371 Date: Nov. 11, 2010

Related U.S. Application Data
(60) Provisional application No. 60/999,343, filed on Oct. 17, 2007.

(51) Int. Cl. G01N 21/00; G06F 19/00

(52) U.S. Cl. 436/89; 702/19; 436/164

(57) ABSTRACT

A strategy, or method, for the quantitative determination of enantiomeric purity that combines lin situ enantiomer diastereomerization', spectroscopy, and chemometric modeling. Spectral data for samples of known enantiomeric composition is subjected to a type of multivariate regression modeling known as partial least squares (“PLS-I”) regression. The PLS-I regression produces a mathematical model that can be used to predict the enantiomeric composition of a set of samples of unknown enantiomeric purity. In this strategy, the guest-host complexation utilizes improved chiral selector molecules, including chiral amines and chiral alcohols such as phenylethylamine and 1,2-propanediol, that form ion pairs or covalent bonds with the chiral analytes.

This application claims priority to U.S. Provisional Patent Application Ser. No. 60/999,343, entitled “Methods for Determining Enantiomeric Purity with Improved Chiral Selectors,” filed on Oct. 17, 2007, the entire content of which is hereby incorporated by reference.

### BACKGROUND

This invention relates to a strategy, or method, for determining the enantiomeric purity of a compound through ‘in situ diastereomerization’ of enantiomers, spectroscopy, and chemometric modeling. The expression ‘in situ diastereomerization’ is used here to mean the transformation of enantiomers into diastereomers in analytical solutions without separation prior to analysis. This is unlike the chromatographic, electrophoretic, and NMR techniques, which require one form of separation or, the other. In particular, this invention relates to the determination of enantiomeric compositions of chiral compounds with improved chiral selector compounds. Depending on the analyte, the in situ diastereomerization could be realized through: (1) covalent bond formation, (2) ionic bond formation, and (3) hydrogen bonding and other van der Waals interactions.

Because of wide differences in the pharmacological and physiological properties of enantiomers, the determination of enantiomeric composition of chiral samples is of considerable interest to chemical research in general and the pharmaceutical industry in particular. In many cases, one enantiomer may be therapeutically active, while the other may be at best, non-active and at worst, toxic or lethal. The need for improved strategies for the assessment of enantiomeric purity arises from increased pressure on the pharmaceutical industry by government agencies for documentation on the pharmacological effects of individual enantiomers and the simultaneous demand in drug development for determination of enantiomeric excess in large combinatorial libraries. As a result of the importance of this subject, the FDA in 1992 issued a mandate requiring that pharmaceutical companies assess the effects of individual enantiomers as well as the purity of manufactured chiral drugs. Currently, chiroptical methods such as circular dichroism (CD) which require no chiral auxiliary agent and non-chiroptical methods like HPLC, GC, NMR, MS and FTIR which require diastereomeric derivatization and/or separation of chiral analytes are widely used. While these methods can be used successfully, they are also very time consuming, expensive, and have low sensitivity in certain cases like NMR, which renders these methods rather less attractive for certain purposes such as high-throughput screening analysis. Rapid, reliable, robust and less expensive techniques are the most desirable.

Traditional methods of chiral analysis include chiroptical methods, in which the analyte interacts with incident polarized electromagnetic radiation. These include polarimetry, Raman optical activity, and electronic and vibrational circular dichroism. Non-chiroptical methods require some form of chiral auxiliary to interact with the enantiomers forming diastereomers. These include separation techniques, such as chromatography and capillary electrophoresis, NMR, and mass spectrometry.

Chromogenic enantioselective chiral hosts are capable of discriminating between enantiomers of chiral guests through a change in the visible absorption spectrum of the enantioselective complex, i.e., through a color change. (Otagiri, et al., Chem. Pharm. Bull., vol. 23, p. 188, 1975; Schiller, et al., J. Chem. Soc., Faraday Trans., vol. 83, p. 3227, 1987; Park, et al., J. Phys. Chem., vol. 98, p. 6158, 1994; Cox, et al., J. Photochem. Photobiol., vol. 39, p. 597, 1984; Bortolus, et al., J. Phys. Chem. A, vol. 106, p. 1686, 2002; Balabai, J. Phys. Chem., vol. 102, p. 9617, 1998). Under this strategy, the complexation of one enantiomer of a chiral substrate with a chiral host results in a visible spectral shift and/or the formation of an entirely new visible band, while little or no color change is observed when the other enantiomer complexes with the chiral host.

Traditonally, cyclodextrins have been used as host molecules. Cyclodextrins (“CDs”) are homochiral barrel-shaped sugar molecules that can form transient, non-covalent diastereomeric guest-host complexes with chiral guest molecules. Because the complexes that are formed are diastereomeric, they have different physical properties. Consequently, there are small changes in their spectra. (Suzuki, Electronic Absorption Spectra and Geometry of Organic Molecules, p. 102, 1967). These small spectral variations are often dismissed as having little utility for predicting the composition of a sample because the variations are small, the bands overlap, and the spectra do not appear to show a consistent trend (such as an offset) with composition. However, chemometric methods, such as multivariate regression, offer a variety of powerful techniques for revealing hidden relationships in data that are not immediately apparent.

Multivariate regression modeling (“MRM”) is widely used in chemistry as a means of correlating spectral data with known compositional changes. (Martens, et al., Multivariate Calibration, 1989). While the use of chemometrics in near-infrared spectroscopy is well-established, its use in other spectral regions, such as the ultraviolet region, is not as common. MRM is used for the chemometric analysis of the spectral data of the solutions containing cyclodextrin guest-host inclusion complexes because the solution spectra are composite spectra, simultaneously containing contributions from complexed species (diastereomeric CD inclusion complexes) as well as uncomplexed species that are present because the complexation reaction is not complete.

U.S. Pat. No. 7,191,070 pertains to the determination of the enantiomeric composition of various chiral guest molecules by multivariate regression modeling of spectral data obtained from solutions containing cyclodextrin as a chiral auxiliary. The premise behind the approach is that inclusion complex formation between the chiral guest analyte and the homochiral CD host results in the formation of transient diastereomeric inclusion complexes with different physical and spectral properties. As a result, it is observed that, for solutions containing a fixed chiral guest concentration and a fixed CD host concentration, the absorption or emission spectra vary slightly as the enantiomeric composition of the samples is changed. The small spectral variations are then correlated with the known enantiomeric composition of the guest analyte using standard multivariate regression modeling techniques such as partial-least-squares regression (PLS-1). U.S. patent application Ser. No. 11/664,079 pertains to a related method for determining enantiomeric purity using cyclodextrin as the chiral selector, but it involves polarimetry as well. U.S. Provisional Patent Application No. 60/724,861 pertains to a related method for determining enantiomeric purity using cyclodextrine as the chiral selector that is not dependent on maintaining a constant concentration of the chiral analyte.

### SUMMARY

This invention relates to a new strategy for the quantitative determination of enantiomeric purity. The strategy combines ‘in situ enantiomer diastereomerization’, spectroscopy, and chemometric modeling. In particular, a type of multivariate regression modeling known as partial least squares (“PLS-1”) regression is used to develop a mathematical model that can be used to predict the enantiomeric composition of a set of samples. Unlike previous methods, this strategy does not depend upon the use of cyclodextrin as the chiral selector molecule and instead uses other chiral discriminators that transform, in situ, enantiomers into diastereomers through hydrogen bonding, other van der Waals interactions, ion pair formation, covalent bonding, or some association.

The general reason for using these chiral selector or discriminating agents is, therefore, to enable the formation of diastereomeric pairs from appropriate enantiomeric pairs. The diastereomeric pairs so formed, would have different and unique properties as expected for any pair of diastereomeric compounds. Unlike enantiomeric pairs, diastereomeric pairs are nonsuperposable optically active compounds. As such they have different non-mirror image spectral properties by which they can be spectrally differentiated using isotropic light. With the application of the appropriate spectroscopic technique, these properties can be utilized in discriminating pairs of enantiomers, transformed into diastereomers, for enantimeric composition determination. In the current method, differences in electronic absorption between diastereomeric pairs, formed from appropriate enantiomeric pairs, are monitored using ordinary UV spectroscopy. Ordinary UV spectroscopy cannot typically be used as an effective tool for discriminating between enantiomeric pairs in solution at low concentrations. This is because it is a non-chiroptical technique. However, novel diastereomer formation strategies using the chiral species allows the use of ordinary UV spectroscopy, combined with multivariate chemometric analysis, for enantiomeric composition or enantiomeric excess determination of appropriate chiral analytes at concentrations much lower than can be detected using most of the chiroptical techniques available.

Classically, UV spectroscopy is not a technique for probing the structure of compounds however, UV spectra do contain structural information. The structural information contained in UV spectra are based on the vibrational modes, which are associated with the electronic transitions of chromophores under investigation. Because chromophores may communicate electronically with other parts of molecules of which they form a component, UV spectra may contain structural information beyond just the chromophore. Usually, except for gas phase samples, structural information contained in vibrational modes hardly appear as fine vibrational bands/structures in UV spectra. Nevertheless, this information is always there because vibrational transitions will always be associated with allowed electronic transitions. The formation of diastereomeric pairs, using (S)-(−)-1-phenylethylamine (S-PEA) and (S)-(+)-1,2-propanediol (S-PD) as chiral discriminating agents, from appropriate enantiomeric pairs, could create distinct spectral differences that can be distinctively probed, using isotropic light, for spectral differenciation of enantiomeric pairs. Unlike diastereomers, most enantiomeric pairs have spectral properties that cannot be effectively distinguished, especially at low concentrations, using isotropic (non-polarized) light. As such, it is impossible to effectively probe, spectrally, the difference between such pairs using techniques like ordinary UV and fluorescence spectroscopy, which employ isotropic light for probing molecules.

Multivariate regression is widely known in many areas of chemistry and can serve as a particularly powerful computational tool for correlating spectral data with known compositional changes in a test set of samples. The basic objective of the method is to develop a mathematical model that relates two sets of variables to each other so that the independent or X-variables can be used to determine the dependent or Y-variable. In this case, the X-variables are the spectral information and the Y-variable is the enantiomeric composition.

To avoid problems with colinearity in the data, all multivariate regression techniques require an orthogonal basis set or coordinate system on which to represent the data. To achieve this condition, modern regression techniques employ projection methods to obtain a series of variance-scaled eigenvectors that can serve as a new coordinate system for the data. This form of data decomposition assures an orthogonal coordinate system for the data. At the same time, it provides a way to reduce the dimensionality of the data because only the major eigenvectors are needed to represent the data. Finally, when the data are represented on the new coordinate system, new insight is often gained as new relationships that were formerly obscured in the old coordinate system are revealed.

Compared with principal component regression, another well known method of MRM, the PLS-1 algorithm is especially powerful as a means of multivariate regression, because both the spectral data and the dependent variable (in this case, enantiomeric composition) are actively involved in the construction of the new basis set of variance-scaled eigenvectors that serve as PLS components. In this way, the PLS regression algorithm focuses on those aspects of the spectral data that are most important in predicting enantiomeric composition.

The use of diastereomers in the determination of enantiomeric purity is known, but the current methods differ from existing methodologies because the spectral differences that result from diastereomer formation do not have to result in spectral features that are resolvable as in NMR with a shift reagent. Instead, the current methods rely on the multivariate regression program to correlate subtle spectral changes that could hardly be correlated by visual inspection. Not wanting to be bound by any theory, the current methods for determining enantiomeric purity, using in situ covalent, ionic or hydrogen bonding diastereomerization and chemometric modeling, typically involved preparing a series of calibration standards containing a fixed concentration of chiral analyte and a fixed concentration of S-PEA or S-PD. The UV-vis absorption spectra of the calibration standards were then obtained and. The spectra were then subjected to multivariate regression analysis with partial-least-squares (PLS-1) regression. The regression model was then used to predict the enantiomeric composition or purity of unknown samples from the absorption spectra of the unknowns.

The previously used chiral selector cyclodextrin forms diastereomers by forming weak transient non-covalent complexes with the chiral analyte whose unique spectral properties can be measured. In the current strategy, (S)-(−)-1-phenylethylamine and (S)-(+)-1,2-propanediol are used as chiral discriminating agents. Not wanting to be bound by any theory, homochiral phenylethylamine, which has an amino group, can react with organic acids to form a quaternary ammonium salts through ion pair or simply ionic bond formation. For the enantiomeric pair of an organic acid, quaternary ammonium salts formed with S-PEA will be diastereomeric. In solution, electrostatic attraction between the quaternary ammonium cation of S-PEA and the carboxyl anions of the pair of enantiomers, of the acid, should result in diastereomeric interactions. This should impart a unique spectral property to the solution. Beside this, diastereomeric interactions in solution, leading to the acquisition of unique spectral properties by the solution, could occur through hydrogen bonding and other van der Waals interactions. (S)-(+)-1,2-propanediol, being an alcohol can react with organic acids in a mineral acid catalyzed reaction like the Fischer esterification to form esters. The diastereomers, thus formed, are actually distinct covalent compounds, which are expected to have distinct spectral properties by which they can be more easily distinguished spectrally, using isotropic light, than their enantiomers. The use of these new chiral selectors actually gives lower analytical errors than previous strategies. Other similar chiral amines and alcohols can also be effective chiral discriminating molecules.

Broadly, one aspect of the present invention involves a method for determining an unknown enantiomeric composition of a chiral compound in an unknown sample using improved chiral selector compounds, comprising the steps of:

(1) preparing a series of known samples, each of the known samples comprising a chiral compound having a known enantiomeric composition associated with an improved chiral selector compound, wherein in each of the known samples, the enantiomeric composition of the chiral compound is varied;

(2) collecting absorption spectral data of the known samples at various wavelengths;

(3) performing a principal component analysis to select a spectral range of wavelengths in which the spectral differences arising in each of the known samples due to an influence of the enantiomeric composition is most appreciable to give a representative range of wavelengths;

(4) performing a partial-least-squares regression of the spectral data over the selected range of wavelengths for each of the series of the known samples to determine a series of regression coefficients;

(5) entering the series of regression coefficients for the selected range of wavelengths into a regression vector;

(6) collecting absorption spectral data of an unknown sample at various wavelengths to give unknown spectral data, wherein the unknown sample comprises the chiral compound of the known samples associated with an improved chiral selector compound; and

(7) inserting the unknown spectral data into the regression vector to allow calculation of the unknown enantiomeric composition of the chiral compound in the unknown sample.

In the current invention, chemometric analysis of spectral data of solutions containing diastereomers formed by in situ diastereomerization of enantiomers, utilizing improved chiral discriminating agents, is used to determine the enantiomeric composition or purity of a number of simple chiral compounds. The spectral data may be collected using any spectroscopic technique such as IR, Raman, NMR, UV-vis and fluorescence. To make the analysis simple, fast, sensitive, and inexpensive for routine analysis, UV-vis absorption and fluorescence spectroscopic techniques, combined with chemometrics, are most preferable.

The method is quite general and can apply to a diversity of compounds. The improved chiral discriminating compound can be any compound that can associate with a given chiral analyte through the formation of ion pairs, covalent bonds, or hydrogen bonding similar to (S)-(−)-1-phenylethylamine or (S)-(+)-1,2-propanediol. Because the method depends solely on the changes in the spectra of sample solutions of pairs of enantiomers induced by the chiral discriminating agents through diastereomerization of enantiomers, it does not necessarily assume or depend on any particular stoichiometry of the chiral analyte and the chiral discriminating agent.

### BRIEF DESCRIPTION OF FIGURES

FIG. 1 shows the UV absorption spectra of 2.5 mM solutions of D- and L-tyrosine-S-PEA complex

FIG. 2 shows the UV absorption spectra of solutions made up of varying ratios of equimolar (2.5 mM) solutions of S-PEA and L-tyrosine;

FIG. 3 shows the UV absorption spectra of solutions made up of varying ratios of equimolar (2.5 mM) solutions of S-PEA and L-tyrosine acidified with HCl;

FIG. 4 shows a Job's Plot showing absorbance at 243 nm as a function of the volume of 2.5 mM solution of S-PEA added to different aliquots of an equimolar solution of L-tyrosine;

FIG. 5 shows the mean centered UV absorption spectra of seventeen 2.5 mM sample solutions of D- and L-Tyr dissolved in 2.5 mM S-PEA solution;

FIG. 6 shows PLS-1 regression model plots of a set of eight randomly selected calibration samples of D- and L-Tyr dissolved in S-PEA solution;

FIG. 7 shows the UV absorption spectra of 4 mM D- and L-Phenylalanine-S-PEA solutions;

FIG. 8 shows the mean centered UV absorption spectra of seventeen 4 mM sample solutions of D- and L-Phe dissolved in S-PEA solution;

FIG. 9 shows PLS-1 regression model plots of a set of eight randomly selected calibration samples of D- and L-Phe dissolved in S-PEA solution;

FIG. 10 shows the UV absorption spectra of 4 mM S-PEA, 4 mM alanine, and 4 mM D- and L-alanine-S-PEA solutions;

FIG. 11 shows the mean centered UV absorption spectra of seventeen 4 mM sample solutions of D- and L-Ala dissolved in S-PEA solution;

FIG. 12 shows PLS-1 regression model plots of a set of eight randomly selected calibration samples of D- and L-Ala dissolved in S-PEA solution;

FIG. 13 shows the UV absorption spectra of 4 mM solutions of (S)-(+)-1,2-propanediol esterified D- and L-phenylalanine;

FIG. 14 shows the mean centered UV absorption spectra of fifteen 4 mM sample solutions of (S)-(+)-1,2-propanediol esterified D- and L-phenylalanine;

FIG. 15 shows the PLS-1 regression model plots of a set of eight randomly selected calibration samples of (S)-(+)-1,2-propanediol esterified D- and L-phenylalanine; and

FIG. 16 shows the root-mean-square error of prediction figures of merit for various chiral discrimination strategies.

FIG. 17 shows (A) the UV spectra of 3 mM solutions of D- and L-Arabinose prepared by dissolving appropriate amounts of D- and L-Arabinose in 3 mM S-1-phenylethylamine (S-PEA) solution and (B) the spectra of 12 mM solutions of D- and L-Arabinose prepared by dissolving appropriate amounts of D- and L-Arabinose in 6 mM S-PEA solution.

FIGS. 18 (A) and (B) show the UV spectra of 3 and 12 mM sample solutions made up of different compositions of D and L-Arabinose solutions prepared by dissolving appropriate amounts of D- and L-Arabinose in 3 and 6 mM S-PEA solutions, respectively.

FIG. 19 shows the PLS-1 regression cross-validation plots of the twelve sample solutions shown in FIG. 18(A).

FIG. 20 shows the PLS-1 regression cross-validation plots of the thirteen samples solutions shown in FIG. 18(B).

FIG. 21 shows the UV absorption spectra of 4 mM (A) and 20 mM (B) solutions of (S)-(+)-1,2-propanediol esterified D- and L-alanine.

FIG. 22 shows the PLS-1 regression cross-validation plots of fifteen sample solutions of different compositions of 4 mM solutions of (S)-(+)-1,2-propanediol esterified D- and L-alanine.

FIG. 23 shows the PLS-1 regression validation plots of thirteen sample solutions of different compositions of 20 mM solutions of (S)-(+)-1,2-propanediol esterified D- and L-alanine.

FIG. 24 shows the UV spectra of 6 mM acetic acid, 6 mM S-PEA, 1:1 equimolar (6 mM) mixture of acetic acid and S-PEA and 3 mM S-1-PEA.

FIG. 25 shows the UV spectra of 6 mM L-alanine, 1:1 equimolar (6 mM) mixture of alanine (Ala) and S-PEA and 3 mM S-PEA solutions.

FIG. 26 shows the UV spectra of aqueous solutions of 6 mM L-Phenylalanine (Phe), 6 mM S-1-PEA, 1:1 equimolar (6 mM) mixture of Phe and S-PEA, 3 mM Phe and 3 mM of S-PEA.

FIG. 27 shows the UV spectra of aqueous solutions of 2 mM Phenol, 1 mM Phenol, 1:1 equimolar (2 mM) mixture of Phenol and S-1-PEA and 2 mM S-1-PEA.

### DETAILED DESCRIPTION OF PREFERRED EMBODIMENTS

The current invention pertains to methods for determining enantiomeric composition or purity of solutions of compounds whose enantiomeric composition is unknown. The methods involve in situ enantiomeric diastereomerization with improved chiral discriminating agents, spectroscopy, and chemometric modeling. A type of multivariate regression modeling known as partial least squares (“PLS-1”) regression is used to develop a mathematical model that can be used to predict the enantiomeric composition of a set of samples. The methods utilize compounds such as (S)-(−)-1-phenylethylamine and (S)-(+)-1,2-1,2-propanediol that are capable of forming ion pairs, hydrogen bonds, or covalent bonds with the chiral analytes.

For solutions containing a fixed concentration of chiral analyte and a fixed concentration of chiral discriminating agent, the UV absorption spectra vary as the enantiomeric composition of the chiral analyte is changed. These spectral changes can then be correlated with the known enantiomeric composition of a training set of samples using standard multivariate regression modeling (partial-least-squares regression, “PLS-1”).

Multivariate modeling of the spectral data is a two-step procedure. In the first or calibration phase, a mathematical model in the form of a regression vector is determined with a training set of samples whose Y-variable is known. In particular, PLS-1 regression is used to construct a linear predictive model for enantiomeric compositions based on the spectral data. The equation below shows the typical format of a regression vector.

X_{R}=k₀+k₁A₁+k₂A₂+ . . . +kₙAₙ

In this equation, X_{R} is the unknown mol fraction of guest molecule in the sample, kᵢ are the coefficients of the regression vector, and Aᵢ are the absorbances at the different i wavelengths (i=1, . . . , n) for a given unknown sample. The variable k₀ is a constant regression coefficient. The regression coefficients (kᵢ) and the regression constant (k₀) are calculated using the PLS-1 regression algorithm, which may preferably be performed on a computer system utilizing suitable software (Unscrambler®, CAMO, Oslo, Norway).

The PLS-1 algorithm is especially powerful as a means of regression because both the X- and the Y-data are actively involved in the construction of the new basis set made up of PLS components. In this way, the PLS regression algorithm focuses on those aspects of the data that are most important in predicting Y. Partial least-squares regression has a goal of minimizing sample response prediction error by seeking linear functions of the predictors that explain as much variation in each response as possible, as well as accounting for variation in the predictors. The techniques implemented in the PLS-1 procedure work by extracting successive linear combinations of the predictors. In particular, the PLS-1 method balances the two objectives, seeking factors that explain both response and predictor variation.

In the second or validation phase of multivariate modeling, the mathematical model developed for the training set of samples is used to predict the enantiomeric composition of another independently obtained set of samples whose enantiomeric composition is also known. Here, the spectral data for the validation set of samples are obtained, and the equation above is used to predict the enantiomeric composition of the samples in the set from the measured spectral data. In this phase, the values of the Y-data predicted by the model are compared with the known values for the validation set.

How well the regression models will predict unknown samples is evaluated in terms of the root-mean-square error of prediction (“RMSEP”) given by the equation

RMSEP=[Σ(xᵢ′−xᵢ)²/n]^{1/2}

where xᵢ is the known ith mole fraction, Xᵢ′ its predicted value and n the total number of sample mole fractions predicted. The RMSEP value depends on how well enantiomers of a pair are discriminated in the analysis. Poor discrimination of enantiomers will result in high RMSEP values and vice versa. RMSEP can therefore be used as a figure of merit in comparing different discrimination strategies.

The strategies of the current invention are useful for determining the enantiomeric compositions of various chiral compounds, including amino acids and pharmaceuticals. Generally, any chiral compound that can interact to form a diastereomeric pair from a pair of enantiomers of an appropriate chiral analyte and has an appreciable absorption band, which is distinct from that of the solvent, can be used. In this particular invention, examples of potential chiral analytes include chiral alkyl halides, chiral alkyl sulfonates, chiral carbonyl compounds, chiral amines, chiral alcohols, chiral carboxylic acids, chiral acid halides or anhydrides, chiral sulfonyl chlorides, chiral alkaloids, and compounds containing combinations of the above functional groups. As such, the enantiomeric compositions of ibuprofen, norephedrine, phenylglycine (“φ-Gly”), glycidyl butyrate, aspartic acid, phenylalanine, and arabinose can be determined. Moreover, because the chiral analysis method does not depend on the specific rotation of the target molecule, it is especially valuable for compounds where polarimetric determinations are problematic due to small specific rotations.

Previously, homochiral cyclodextrins, modified homochiral cyclodextrins, surfactants, and chiral ionic liquids were used as chiral discriminators for the determination of enantiomeric composition of samples. These chiral discriminators induce diastereomeric properties in enantiomers through transient interactions including van der Waals interactions, dipole interactions, and hydrogen bonding interactions. Despite the satisfactory performance of cyclodextrins, they have some drawbacks as chiral discriminators. These drawbacks include poor solubility, dependency of discrimination on a formation constant of the inclusion complex, and the dependency of the inclusion complex formation on the size of the analyte in relation to the cyclodextrin cavity. To circumvent these limitations as well as those associated with the other transient non-covalent chiral discriminators, the current method utilizes a new discrimination strategy. This strategy involves discriminating between enantiomers by the formation of true covalent, ionic, or/and non-transient hydrogen bonding complex diastereomers of the enantiomers. Because the members of a pair of diastereomers are two different compounds with distinct properties, a pair of enantiomers transformed into a pair of non-transient covalent or ionic or hydrogen bonding complex diastereomers, would be spectroscopically more distinguishable. Once the spectra of the enantiomers, transformed into diastereomers, become more distinguishable, change in spectra with composition becomes more sensitive. The correlation between spectra and enantiomeric composition becomes stronger leading to lower error in analysis than strategies involving transient diastereomerization that have to deal with smaller spectral differences.

In preferred embodiments, the current method utilizes (S)-1-phenylalanine (“S-PEA”) and (S)-(+)-1,2-propanediol (“S-PD”) as chiral discriminating agents. (S)-1-phenylethylamine (S-PEA) acts as an ionic bond or hydrogen bond forming diastereomerization chiral discriminating agent in the enantiomeric composition determination of various amino acids, including Ala, Phe and Tyr. Homochiral (S)-(+)-1,2-propanediol (“S-PD”) acts as a covalent diastereomerization chiral discriminator through ester formation in the enantiomeric composition determination of various amino acids, including Phe. These preferred embodiments utilize UV/vis absorption spectroscopy and PLS-1 multivariate regression modeling of spectral data in order to determine enantiomeric composition or purity.

(S)-(−)-1-phenylethylamine (“S-PEA”) (or alpha-methylbenzylamine) is considerably soluble in water (0.04 mg/mL) and has a pka value of 9.83. It can be obtained in high purity (≧99%). S-PEA will act as a Bronsted-Lowry base toward a Bronsted-Lowry acid with the appropriate pka value (less than 9.83). Under this condition, a quaternary salt will be formed with the acid, where S-PEA will end up forming a quaternary ammonium cation. Generally, classes of compounds with which S-PEA could form quaternary ammonium salts include carboxylic acids, alcohols that will form stable alkoxides in solution and other compounds containing acidic hydrogen with appropriate pka values (less than 9.83). In addition, S-PEA can act as a Lewis base toward appropriate Lewis acids to form coordinate covalent compounds. Furthermore, S-PEA can participate in both hydrogen bonding (H-bonding) and aromatic π-system interactions, which could lead to the formation of stable conformers in solution. The ability to form stable conformers is important for discriminating between enantiomers via diastereomerization.

As a chiral compound, (S)-(−)-phenylethylamine can interact with an appropriate pair of a pair of enantiomers through: (1) ion pair formation (quaternary ammonium salt formation), (2) coordinate covalent bond formation (lone pair electron sharing interactions), (3) hydrogen bonding and aromatic π-system association, leading to the formation of pairs of diastereomeric products. These diasteromeric pairs will have different properties, including different spectral properties. These properties can be utilized, with the appropriate technique, as a means of discriminating between enantiomeric pairs and for enantiomeric composition or enantiomeric excess analysis. For the analysis described herein, S-1-PEA is use in forming diastereomeric pairs from appropriate enantiomeric pairs. Ordinary UV spectroscopy is employed to probe the spectral difference between the diastereomeric pairs formed and multivariate chemometrics is used in analyzing the spectral data.

S-PEA is preferred as a chiral selector in the current enantiomeric composition determination strategy because: (1) S-PEA can form diastereomeric pairs with a large number of chiral analytes through a variety of molecular interactions, (2) it has considerably sensitive UV active chromophore, which is sensitive to changes in the molecule as a result of interaction with analyte molecule, (3) it is appreciably soluble in a large number of solvents, including water, which will allow analysis to be conducted in a variety of solvent media, (4) S-PEA enhances the solubility of certain analytes with poor solubility in water, and (5) its usual point of interaction (amine group) with appropriate chiral analytes is a chromophore, which is in close proximity (within two bonds) with a highly sensitive UV active chromophore (aromatic π-system: phenyl group). The close proximity of these chromophores is important because changes in one of them as result of interaction with an analyte could reflect in the other. As such, spectral differences in pairs of diastereomers, formed with S-PEA, are communicated through the chromophores and depicted in UV spectra.

The stronger the type of interaction or bond between S-PEA and the analyte, the higher the chances of discrimination. This is because stable diastereomers are less liable to conformational changes that may lead to the formation of identical species in solution. In addition, isolation of S-PEA and chiral analyte molecules from each other, through solvation, will be limited. The tendency of solvent molecules to isolation S-PEA and chiral analyte molecules from each other, through salvation, will limit discrimination because effective interaction between the chiral discriminating agent and the analyte molecules will be curtailed hence the formation of distinct diastereomeric species in solution. This will consequently minimize the chances of discriminating between enantiomeric pairs. Situations like this can be circumvented by carrying out the analysis at higher concentrations. This is because as the concentration intermolecular interactions become more effective. The selection of an appropriate concentration can be done by determining the concentration at which the difference in spectra, in terms of intensity or shift in wavelength, of the solutions of a pair of diastereomers, formed from a pair of enantiomeric, is greater than the given instrument error. This is illustrated in Example 7 below.

The compound, (S)-(+)-1,2-propanediol, is a chiral alcohol that can be obtained in high purity (≧99%) and can react with a number of functional groups, in various compounds, to form covalent compounds. The reaction of chiral S-PD with pairs of appropriate chiral analytes will result in the formation of pairs of diastereomeric products. As a short-chain aliphatic dialcohol, S-PD is soluble in water. As part of the analytical solution, unreacted S-PD is capable of increasing the solubility of diastereomeric pairs of chiral analytes, which may have low solubility in pure water. The diastereomeric pairs formed between this alcohol and pairs of appropriate enantiomers will have different spectral properties by which they can be analyzed using spectroscopic techniques employing isotropic light.

As part of the current strategy for enantiomeric composition and enantiomeric excess analysis of amino acids, a special protocol is used for the formation of covalent diastereomeric pairs, using S-PD in addition to the use of S-PEA in ionic and hydrogen bond induced diastereomeric pair formation. This is intended for the analysis of chiral analytes containing carboxylic acid groups among others. S-PD is preferred in this covalent diastereomerization approach because: (1) it can react with various functional groups and (2) it is the smallest, less hindered, aliphatic, chiral alcohol with one of its hydroxyl group directly attached the steroegenic carbon and the other within two bonds from the sterogenic carbon. Unlike S-PEA, S-PD has no chromophores that absorb UV in wavelength regions different from that of water, which is the solvent used in the current study. In situations such as this, it is important for the chiral analyte to have a chromophore with considerable absorption coefficient in wavelength regions significantly different from water. For example, an attempt to use S-PD for enantiomeric composition determination of aniline, which has which weakly absorbing chromophores of —NH₂ and —COOH, failed at 4 and 20 mM concentration levels as shown in Example 8 while phenylalanine was successfully analyzed at a concentration of 4 mM.

As noted earlier, S-PEA will react with a protic organic acid to form quaternary ammonium salts of the acids. For enantiomers of chiral organic acids, the quaternary salts formed are diastereomerically related to each other hence their ionic pairs in solution. As explained earlier, the diastereomeric pairs so formed will have different spectrally properties among others. By this, S-PEA is used to achieve chiral discrimination or recognition of the enantiomers. This chiral discrimination or recognition, effected by S-PEA will allow for spectroscopic discrimination of enantiomers. The UV-vis absorption spectra of sample solutions containing different compositions but identical total concentration of diastereomeric ion pairs, formed through interaction with S-PEA, are therefore expected to correlate with the enantiomeric composition of the sample solutions. Similarly, the formation of non-transient hydrogen bonding complexes should lead to diastereomeric differences between enantiomers, which can be exploited for enantiomeric composition analysis. The S-PD on the other hand is used to achieve chiral discrimination or recognition by the formation of esters through the carboxylic acid groups (—COOH) of the analytes using the Fischer esterification procedure. The esters formed with the homochiral S-PD are diastereomerically related to each other. Similarly, this chiral discrimination or recognition, effected by the S-PD, should lead to spectroscopic discrimination or recognition of the enantiomers. The UV/vis absorption spectra of sample solutions containing different compositions but identical total concentration of the esters should therefore correlate with the enantiomeric composition of the sample solutions.

Other chiral amine and alcohols, similar to S-PEA and S-PD can be used for enantiomeric composition and enantiomeric excess analysis. Chiral amines, apart from S-PEA that can be used for enantiomeric composition or enantiomeric excess analysis, employing UV/vis spectroscopy combined with multivariate chemometrics, should be able to: (1) react as Bronsted-Lowry or Lewis bases towards apprppriate chiral analytes that will behave as Bronsted-Lowry or protic Lewis acids to form diastereomeric ion pair species in solution, (2) form coordinate covalent bonds with apprpriate chiral analytes to form coordinate covalent diastreomeric compounds in solution, (3) interact through hydrogen bonding with appropriate pairs of chiral analytes to form hydrogen bonded species with stable conformations in solution, (4) have chromophores with high absorption coefficient in the UV-vis region, significantly different from the solvent used, and (6) have chromophores which constitute or are close to (within two bonds) the point of interaction with the chiral analyte.

While a large number of chiral amines may qualify according to the criteria above, there might be limitations when it comes to analyzing samples in water as the solvent. For example, attempts have been made to use (+)-Bis[(R)-1-phenylethyl]amine, (S)-(−)-N-Benzyl-1-phenylethylamine, and (S)-(−)-1-(1-Naphthyl)-ethylamine for enantiomeric composition analysis in water as the solvent but without success because these amines have very low solubility in water. As such, the effect of the interactions with enantiomeric pairs lack the magnitude or intensity at which they can be adequately differenciated in spectra for the analysis. The use of such amines will therefore require solvents in which both the amine and the chiral analyte are significantly soluble. S-PEA therefore seems to be unique in this capacity. Chiral amines synthesized with appropriate functional groups, which will improve water solubility, can be employed in the current strategy for enantiomeric composition and enantiomeric excess analysis using water as a solvent.

With chiral alcohols, the requirements that need to be met for enantiomeric composition and enantiomeric excess analysis include: (1) having an appropriate steric environment around the —OH group to enable it to take part in Fischer esterification reaction with carboxylic acid functional group containing chiral analytes, (2) having an —OH group that is at most within two bonds from the chiral center, and (3) possessing a chromophore that absorbs UV sufficiently in wavelength regions significantly different from that of the solvent used if the analyte has none. One preferred example is R/S-2-butanol.

Amines and alcohols can react with a number of functional groups in a variety of compounds to form different diastereomeric products besides those discussed here. As such, any possible reaction that the above-mentioned chiral selectors or resolving agents, including any that qualifies according to the criteria above, can undergo, can be used in accordance with the current method. It is recognized that there will be the need to use other solvents apart from water. In addition, other spectroscopic techniques such as IR and Raman, among others, can be employed with the current strategy for enantomeric composition and enantiomeric excess analysis. It is important to note that reactions that may lead to loss of optical activity in products are not guaranteed to work with these strategies.

### Example 1

### Sample Preparation and Data Analysis

Enantiopure (S)-(+)-1,2-propanediol, D- and L-alanine, D- and L-phenylalanine, D- and L-Tyrosine and doubly-deionized water used throughout the experiment were purchased from Aldrich Chemical Company (Milwaukee, Wis.). Enantiopure (S)-1-phenylethylamine was purchased from Alfa Aesar (Ward Hill, Mass.) and used as received. All chemicals were used as received.

To prepare samples for the experiments involving S-PEA, one liter stock solution of approximately 4 mM S-PEA was prepared by dissolving an appropriate amount of S-PEA in some volume of deionized water. This was quantitatively transferred into a 1 L volumetric flask and made up to the mark. A 2.5 mM stock solution was then prepared from the 4 mM stock solution by diluting 125 mL of the 4 mM stock solution contained in a 250 mL volumetric flask with deionized water to the mark. Separate 4 mM stock solutions of D- and L-phenylalanine or D- and L-alanine were then prepared by dissolving accurately weighed appropriate amounts of the enantiomers in appropriate volumes of the 4 mM S-PEA stock solution. A 2.5 mM stock solution of D- or L-tyrosine was also prepared for analysis by dissolving accurately weighed amount of D- or L-tyrosine in an appropriate volume of the 2.5 mM S-PEA stock solution. For each analyte of Ala, Phe and Tyr, a set of calibration and validation samples were prepared by mixing together, using an eppendorf pipette, appropriate volumes of the D- and L-stock solutions. The sample solutions prepared for each analyte were made up of different compositions of the corresponding pair enantiomers but identical total concentration of the analytes as well as the S-PEA chiral discriminating agent.

An example of the determination of the stoichiometry for optimum interaction between the chiral analyte and S-PEA was performed for tyrosine. To do this, aliquots of equimolar solutions of L-tyrosine and S-PEA were mixed such that the total concentration of L-tyrosine and S-PEA remained constant in each solution mixture. The UV-vis absorption of each solution was measured at an appropriate wavelength and a graph of absorbance as a function of the volume composition of S-PEA. Furthermore the effect of pH on the interaction between L-tyrosine and S-PEA was demonstrated using a second set of acidified equimolar solutions of L-tyrosine and S-PES prepared in a similar manner. A graph of absorbance, at the same wavelength as the non-acidified solutions, as a function of the volume composition of S-PEA was plotted for comparison. This procedure illustrates the ‘in situ enantiomer diastereomerization’ strategy in which the transformation of the enantiomers into diastereomers was incorporated in the preparation of the analytical solution.

To prepare samples for the experiments involving S-PD, separate 4 mM stock solutions of D- and L-phenylalanine ester hydrochlorides of S-PD were prepared by adding an appropriate amount of S-PD and an appropriate amount of concentrated HCl to accurately weighed appropriate amounts of enantiopure D- and L-phenylalanine contained in a 24 ml glass vials. The samples were then heated together in a water bath at 70° C. for an hour and allowed to cool to room temperature. The preparations were quantitatively transferred into pre cleaned volumetric flasks with deionized water and made up the mark with the same. A set of calibration and validation samples were prepared by mixing, using an eppendorf pipette, appropriate volumes of the D- and L-stock solutions. The sample solutions prepared were made up of different compositions of the enantiomers but identical total concentration of S-PD reacted phenylalanine. Similar to the S-PEA procedure, this procedure illustrates the ‘in situ enantiomer diastereomerization’ strategy as applied to esterification in which the transformation of the enantiomers to ester diastereomers was incorporated in the preparation of the analytical solution. This is completely different from other techniques where enantiomers are derivatized and separated for analysis. The technique described herein is simpler, less time-consuming, less expensive, and suitable for routine analysis.

The UV-vis absorption spectrum of each sample, contained in a 10 mm pathlength, quartz cell, was recorded using a Hewlett-Packard photodiode array UV-vis spectrophotometer (Model 8453). A set of calibration samples were randomly selected from a given total of each analyte. The spectral and enantiomeric composition data of the calibration samples were then subjected to multivariate regression analysis using commercial chemometric software (The Unscrambler™ version 9.6; CAMO, Inc., Oslo, Norway). Particularly, partial-least-squares (PLS-1) calibration models were developed from the data of calibration samples over different wavelength regions, selected by mean centering the spectra of the calibration samples. The calibration models were cross-validated. The calibration model with the least root mean square error of prediction (RMSEP) was selected among the others and the spectral wavelength associated with it noted. This calibration model was then used in predicting a set of validation or test samples of each analyte. The test sample were made up of enantiomeric compositions that were entirely different from the calibration samples. The test samples were predicted over the same wavelength range used for developing the best calibration model. The enantiomeric compositions predicted by the calibration model were then compared with the know values by computing the root mean square error of prediction for the test or validation samples. This is used to verify the efficiency of the analytical technique.

### Example 2

### Tyrosine Analysis

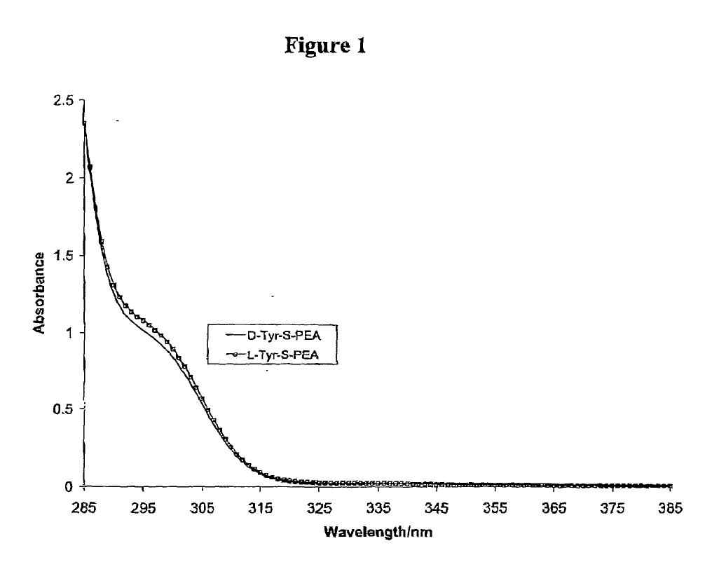

FIG. 1 shows the UV absorption spectra of 2.5 mM solutions D- and L-Tyr prepared by dissolving appropriate amounts of the enantiomers in appropriate volumes of the 2.5 mM S-PEA stock solution. The insert in the top left corner of the figure shows the complete spectra recorded from 260-360 nm and the bottom right corner insert shows the two spectra from 313-363 nm. The figure shows that there is a significant difference in spectral signature between the D-tyrosine-S-PEA and L-tyrosine-S-PEA complexes. The bottom right corner insert reveals the spectra crossing each other at 340 nm. The top left corner insert reveals the usual absorption maximum of tyrosine at 274 nm, which is due to the phenolic group.

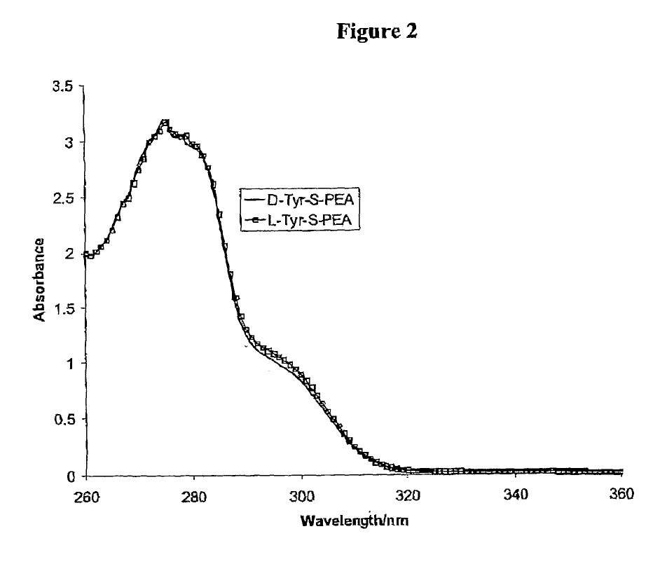

FIG. 2 shows the spectra of the 2.5 mM equimolar solutions of S-PEA and L-Tyr. The solutions were made up of different amounts of tyrosine and S-PEA, which were varied at a regular interval. The total amount of tyrosine and S-PEA, however, remained constant from solution to solution. The insert on the right shows the ratios in which the tyrosine and S-PEA were mixed. FIG. 2 reveals bathochromic and hyperchromic effects in the spectra of the solutions mixtures in the wavelength regions from about 236-252 nm and 289-313 nm. This indicates changes in the light absorption properties of the tyrosine-S-PEA solution. FIG. 2 also shows that maximum bathochromic and hyperchromic effects are obtained when the ratio between tyrosine and S-PEA is 1:1. This indicates that a complex is formed between tyrosine and S-PEA. The difference in spectra, shown in FIG. 1, is therefore due to the formation of tyrosine-S-PEA diastereomeric complexes. The enantiomers are therefore discriminated. The maximum effect shown by the 1:1 ratio indicates that maximum chiral discrimination is observed when the mole ratio between S-PEA and Tyr is 1:1.

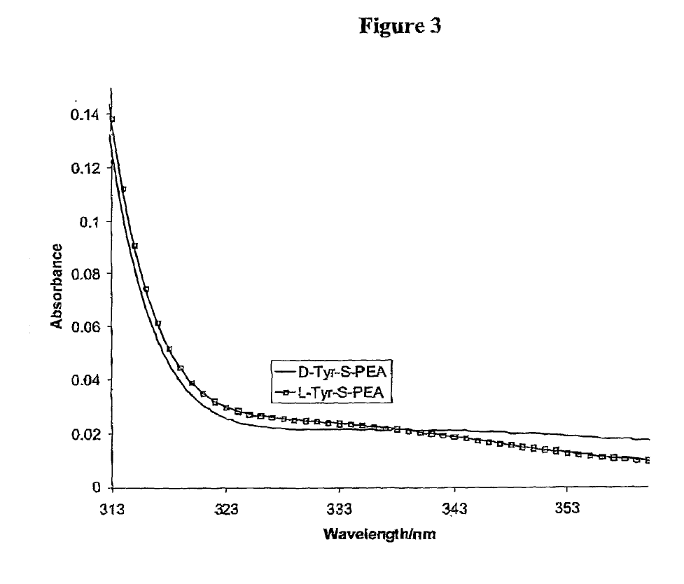

FIG. 3 represents the spectral results of an experiment similar to that shown in FIG. 2 using the same 2.5 mM solutions of S-PEA and L-Tyr solutions acidified with HCl. FIG. 3 shows that acidifying the solutions completely eliminates the bathochromic and hyperchromic effects shown in FIG. 2. This indicates that acidifying the solutions prevents the formation of the tyrosine-S-PEA complex. This in turn implies that the complex is formed between functional groups that remained protonated in the solutions. Because the phenolic group of tyrosine has a pka value of 10.1 compared with 2.20 of the carboxyl acid functionl group, it will be preferentially protonated. The tyrosine-S-PEA complex is, therefore, formed through hydrogen bonding between the phenolic group of tyrosine and the amine group of S-PEA.

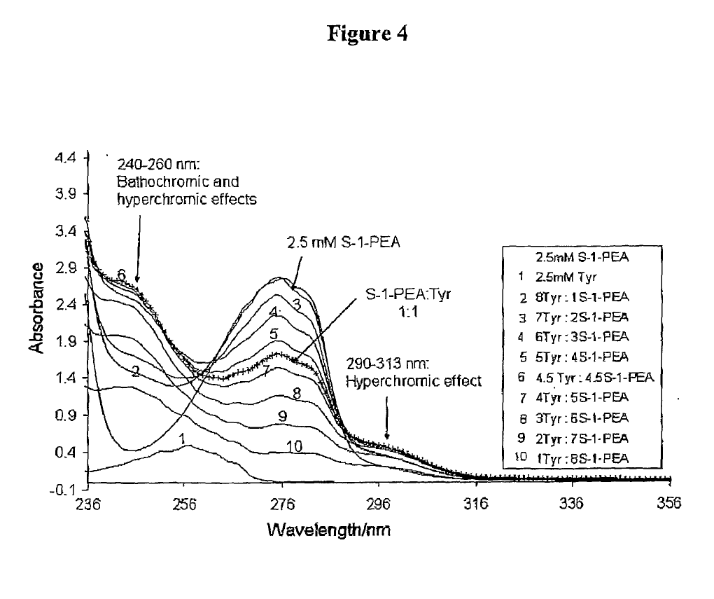

FIGS. 4a and b, respectively, show the Job's Plot of the non-acidified and acidified 2.5 mM equimolar tyrosine and S-PEA solution mixtures prepared in regularly varying tyrosine to S-PEA ratios. FIG. 4a reveals that an absorption maximum is reached at 243 nm when the ratio between equal amounts of tyrosine and S-PEA is 1:1. This confirms the stoichiometry of the tyrosine-S-PEA complex to be 1:1 and indicates that for a given concentration of tyrosine, an equal amount of the S-PEA chiral discriminating agent is needed for optimum discrimination. FIG. 4b on the other hand shows a straight line instead of the parabola-like curve with a maximum shown in FIG. 4a. This indicates the complete absence of stoichiometry between tyrosine and S-PEA hence the absence of complex formation.

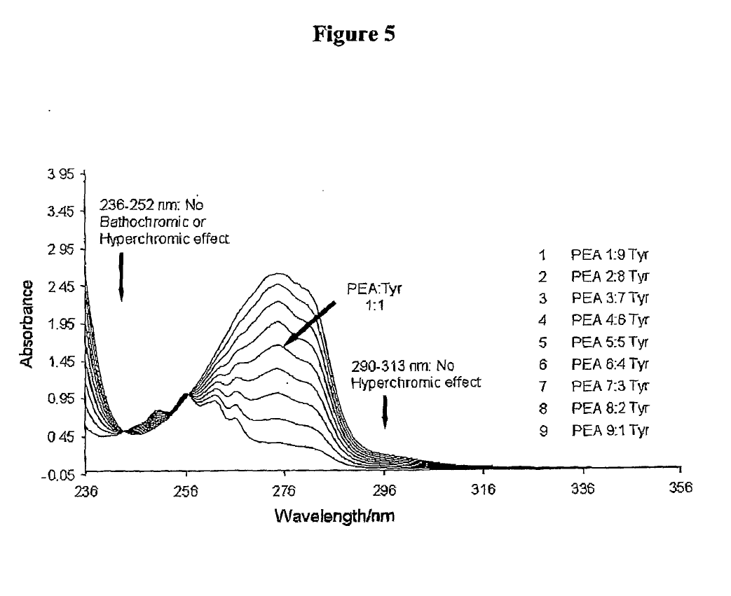

FIG. 5 shows the mean centered spectra of seventeen samples solutions of 2.5 mM D- and L-Tyr dissolved in 2.5 mM S-PEA stock solution. The sample solutions are made up of varying enantiomeric compositions of D- and L-Tyr but identical total concentration of tyrosine and the S-PEA chiral discriminating agent. The insert is the original spectra of the seventeen samples from 260-360 nm. FIG. 5 reveals that the spectra vary with the sample composition. WThis indicates that diastereomeric complexes of D- and L-tyrosine-S-PEA were formed. Worth noting also is the presence of an isosbestic point at 340 nm. This further confirms the presence of two different absorbing species (diastereomers of the tyrosine-S-PEA complexes) in solution having the same absorption coefficients at 340 nm.

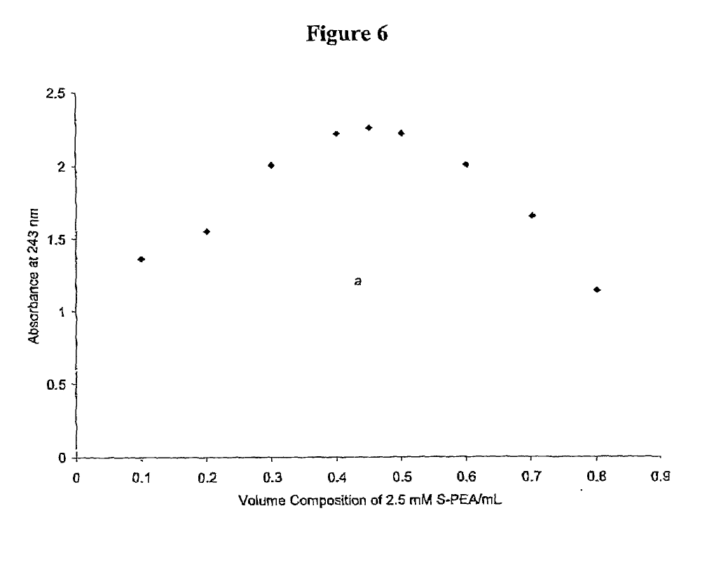

FIGS. 6A, B C, and D show the PLS1 regression modeling plots of a set of eight tyrosine-S-PEA calibration samples (0.0500, 0.100, 0.350, 0.500, 0.600, 0.700, 0.850 and 0.950 in terms of D-Tyr mole fraction) randomly selected among the seventeen samples whose spectra are shown in FIG. 5. The scores plot shown by FIG. 6A, indicates that the samples are divided into four groups according to similarity represented by the quadrants. FIG. 6A also shows that there are no outliers in the sample because none of the samples falls outside the quadrants. FIG. 6B is the coefficient of regression plot, which shows that the variation in the spectral data in the wavelength range from 317-500 nm, strongly describes the variation in the composition of the samples. This is because the curve shown in the plot assumes the shape of the original spectra in that region and shows significantly low noise modeling. The residual variance plot, shown by FIG. 6C, is a plot of the residuals (unexplained data) as a function of principal components. This figure indicates that the variation in the spectral data, in the wavelength range, 317-500 nm, as extracted by the principal components, significantly explains the variation in the enantiomeric composition of the samples. This is because the unexplained part (residuals) associated with each principal component is negligibly low. FIG. 6D is the cross-validation regression plot, which is a plot of predicted enantiomeric compositions, predicted from the spectral data, as function of known enantiomeric compositions. The figure shows a strong regression of the predicted enantiomeric composition on the known enantiomeric composition of the calibration samples. The plot statistics, shown in the figure, reveal a slope of 0.999, a correlation coefficient of 0.999, an offset of 0.0006, and a negligible root mean square error of prediction (RMSEP) of 0.010 for the calibration samples. The value of the RMSEP, which has the same units as the enantiomeric composition (mole fraction units), is much lower than the regular mole fraction interval of 0.05 mole fraction units between the calibration samples. This indicates that the chances of predicting a given sample as the one before or next to it are negligible. The statistics as a whole show that the spectral data strongly correlates with the enantiomeric composition of the calibration samples. Table 1 below shows the prediction of independently prepared test samples used to validate the predictability and robustness of the PLS1 regression model developed from the spectral and enantiomeric composition data of the calibration samples. The value of the root-mean-squares prediction error for the analysis is only 0.006. This is a proof of the efficiency of the discrimination strategy involving (S)-(−)-1-phenylethylamine and the analysis procedure as a whole.

TABLE 1

| Actual mole | Predicted mole | Actual mole | Predicted mole |
|---|---|---|---|
| fraction of | fraction of | fraction of | fraction of |
| D-Tyr | D-Tyr | L-Tyr | L-Tyr |
| 0.100 | 0.101 | 0.900 | 0.899 |
| 0.250 | 0.250 | 0.750 | 0.750 |
| 0.300 | 0.303 | 0.700 | 0.697 |
| 0.400 | 0.401 | 0.600 | 0.599 |
| 0.450 | 0.462 | 0.550 | 0.538 |
| 0.650 | 0.659 | 0.350 | 0.341 |
| 0.750 | 0.758 | 0.250 | 0.242 |
| 0.800 | 0.802 | 0.200 | 0.198 |
| 0.900 | 0.901 | 0.100 | 0.099 |

RMSEP for D-Tyr and L-Tyr = 0.006

### Example 3

### Phenylalanine Analysis

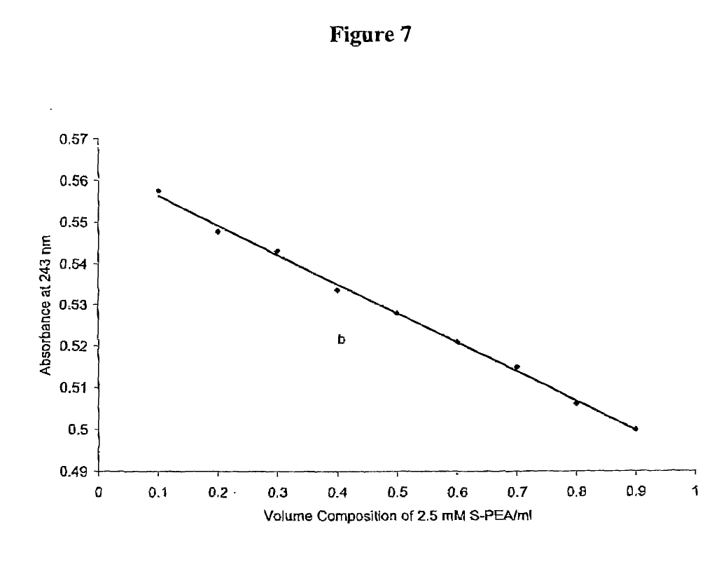

FIG. 7 shows the UV absorption spectra of the 4 mM S-PEA stock solution and 4 mM stock solutions of D- and L-Phe dissolved in the 4 mM S-PEA stock solution. The top right corner insert is the mean centered spectra of the D- and L-phenylalanine-S-PEA stock solutions. The insert reveals that there is a significant difference in absorbance between the D- and L-Phe-S-PEA solutions. This indicates that D- and L-Phenylalanine-S-PEA diastereomers were formed in solution due to interaction between the enantiomers and the S-PEA chiral discriminating agent.

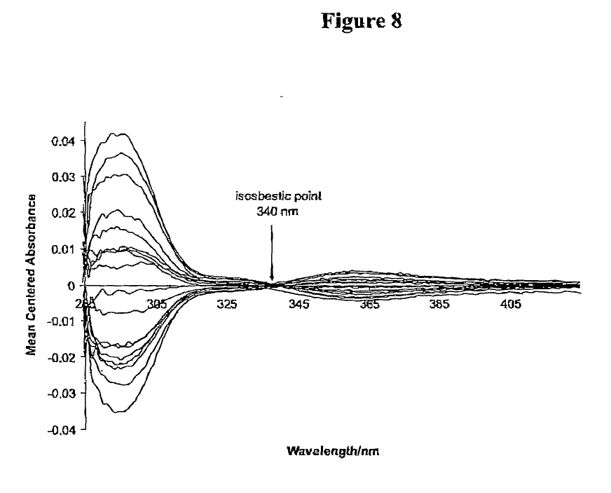

FIG. 8 shows the mean centered spectra of seventeen phenylalanine-S-PEA sample solutions having different D- and L-Phe enantiomeric compositions but identical 4 mM total concentration of phenylalanine and S-PEA. The top right corner insert is the original spectra of the seventeen samples, which hardly reveals any difference between the samples. The mean centered spectra, however, clearly show that the variation in samples composition is reflected in spectra. This confirms that D-Phe is diastereomerically differentiated from L-Phe by S-PEA.

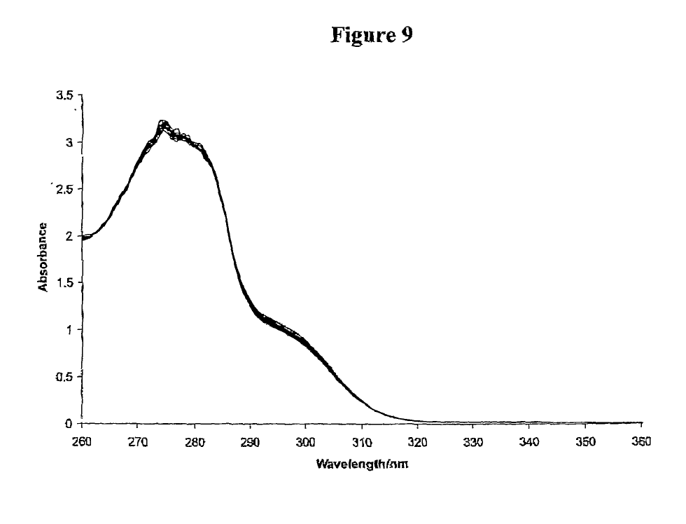

FIGS. 9A B, C, and D are the PLS1 regression model plots of eight randomly selected calibration samples (0.0500, 0.100, 0.200, 0.392, 0.500, 0.527, 0.700 and 0.950 in terms of D-Phe mole fraction). The PLS-1 regression plots are similar to those of tyrosine. The scores plot, FIG. 9A, shows that the calibration samples are divided according to similarity into four categories, with no outliers. The regression coefficient in FIG. 9B indicates that the wavelength range (220-260 nm) modeled, strongly describes the variation in the calibration samples (enantiomeric composition). The residual variance plot of FIG. 9C shows that variations in the spectral data extracted by each principal component, in the selected wavelength range (220-260 nm) almost perfectly describes the variation in the composition of the calibration samples. The cross-validated regression plot, shown in FIG. 9D, which summarizes the effectiveness of the analysis shows that the regression line has a slope of 0.996, a correlation coefficient of 0.998, an offset of 0.002, and a RMSEP of 0.018. These statistics indicate a strong correlation of spectral data with enantiomeric composition of the calibration samples. The PLS1 model developed from the calibration samples was validated with nine independently prepared test solutions. The validation/prediction results of this analysis together with the associated errors of prediction (“RMSEP”) are given in Table 2 below. The root-mean-squares errors of prediction computed for this analysis are 0.013 for D-Phe and 0.011 for L-Phe. The average RMSEP is 0.012. Similar to the Tyr analysis, the low values of the RMSEPs obtained strongly point to the efficiency of the discrimination technique.

TABLE 2

| Actual mole | Predicted mole | Actual mole | Predicted mole |
|---|---|---|---|
| fraction of | fraction of | fraction of | fraction of |
| D-Phe | D-Phe | L-Phe | L-Phe |
| 0.150 | 0.185 | 0.850 | 0.823 |
| 0.267 | 0.264 | 0.733 | 0.738 |
| 0.352 | 0.348 | 0.648 | 0.649 |
| 0.468 | 0.464 | 0.532 | 0.529 |
| 0.486 | 0.483 | 0.514 | 0.515 |
| 0.527 | 0.524 | 0.473 | 0.465 |
| 0.600 | 0.597 | 0.400 | 0.397 |
| 0.650 | 0.640 | 0.350 | 0.346 |
| 0.819 | 0.814 | 0.181 | 0.161 |

RMSEP for D-Phe = 0.013 and L-Phe = 0.011

### Example 4

### Alanine Analysis

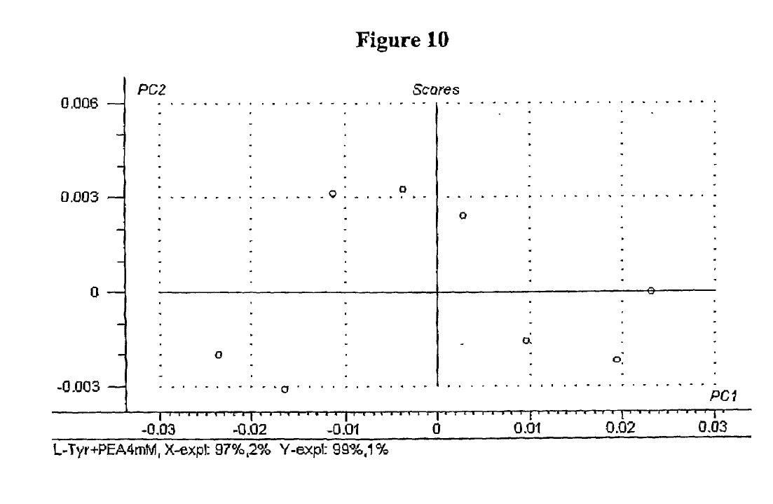

FIG. 10 shows the UV absorption spectra of the 4 mM S-PEA stock solution and those of the 4 mM D- and L-Ala stock solutions made by dissolving appropriate amounts of the enantiomers in the 4 mM S-PEA stock solution. The figure also shows the UV absorption spectrum of a 4 mM solution of only D-alanine. The top right corner insert is the mean centered spectra of the 4 mM D- and L-alanine-SPEA stock solutions. Mean centered spectra show that the spectrum of the D-alanine-S-PEA solution is different from that of the L-alanine-S-PEA solution. Similar to tyrosine and phenylalanine, this observation indicates that diastereomers of alanine were formed in solution by the interaction of D- and L-Ala with the S-PEA chiral discriminating agent.

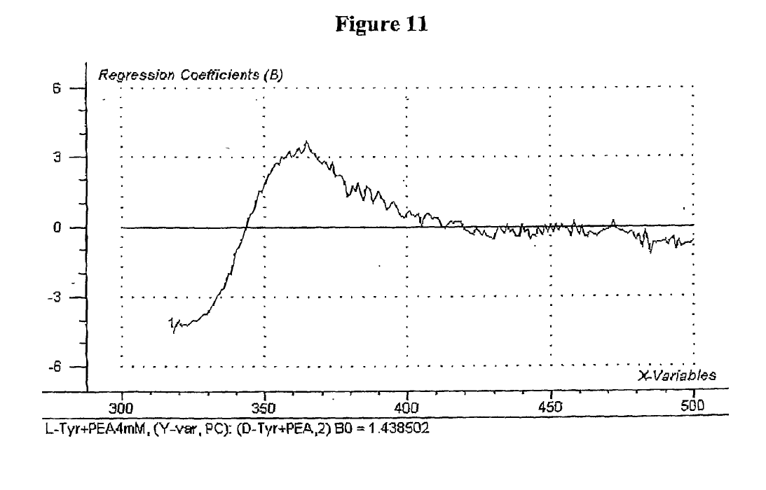

FIG. 11 shows the mean centered spectra of fourteen lalanine-S-PEA sample solutions having different D- and L-Ala enantiomeric compositions but identical 4 mM total concentration of alanine and S-PEA. The top right corner insert is the original spectra of the fourteen samples, which hardly reveals any difference between the samples. The mean centered spectra, however, clearly show that the variation in samples composition is reflected in spectra, similar to tyrosine and alanine. This confirms that D-Ala is diastereomerically differentiated from L-Ala by S-PEA.

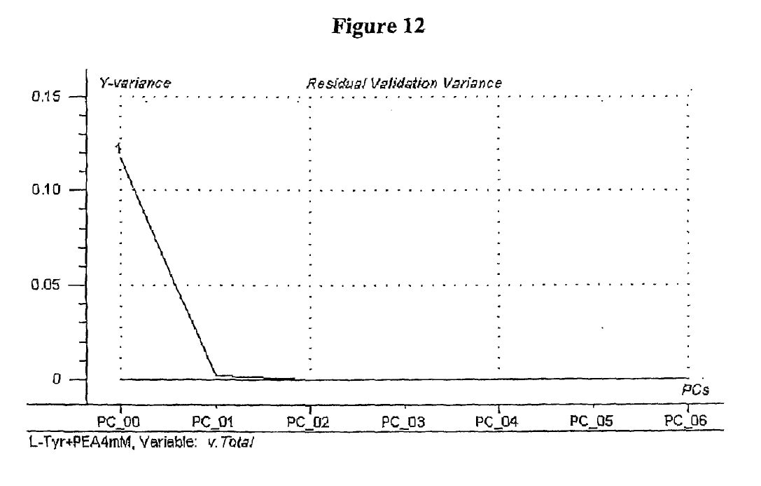

FIGS. 12A B, C, and D are the PLS1 regression model plots of nine randomly selected calibration samples (0.0500, 0.100, 0.250, 0.350, 0.500, 0.650, 0.750, 0.850 and 0.950 in terms of L-Ala mole ratio). The PLS-1 regression plots have characteristics that are similar to those of tyrosine and phenylalanine: (1) The scores plot in FIG. 12A shows that the calibration samples fall into four similarity groups with no outliers. (2) The regression coefficient in FIG. 12B indicates that the wavelength range, 230-975 nm, strongly describes the variation in the calibration samples (enantiomeric composition). (3) The unexplained data shown in the residual variance plot of FIG. 12C for each principal component, in the selected wavelength range (230-975 nm) is negligible. (4) The calibration regression plot, shown in FIG. 12D, which summarizes the effectiveness of the analysis, has a slope of 0.998, a correlation coefficient of 0.999, an offset of 0.001, for the regression line and a RMSEP of 0.014 for the cross-validation prediction of the calibration samples. These statistics indicate a strong correlation of spectral data with enantiomeric composition of the calibration samples. The PLS1 model developed from the calibration samples was validated with five independently prepared test solutions. The validation/prediction results of this analysis together with the associated errors of prediction (“RMSEP”) are given in Table 3 below. The root-mean-squares error of prediction computed for this analysis is 0.018. Similar to the previous results, the error in this analysis shows that the discrimination strategy is efficient.

TABLE 3

| Actual mole | Predicted mole | Actual mole | Predicted mole |
|---|---|---|---|
| fraction of | fraction of | fraction of | fraction of |
| D-Ala | D-Ala | L-Ala | L-Ala |
| 0.800 | 0.789 | 0.200 | 0.211 |
| 0.700 | 0.721 | 0.300 | 0.279 |
| 0.600 | 0.596 | 0.400 | 0.404 |
| 0.400 | 0.369 | 0.600 | 0.631 |
| 0.300 | 0.308 | 0.700 | 0.692 |

RMSEP for D-Ala and L-Ala = 0.018

### Example 5

### Phenylalanine Esterification Analysis

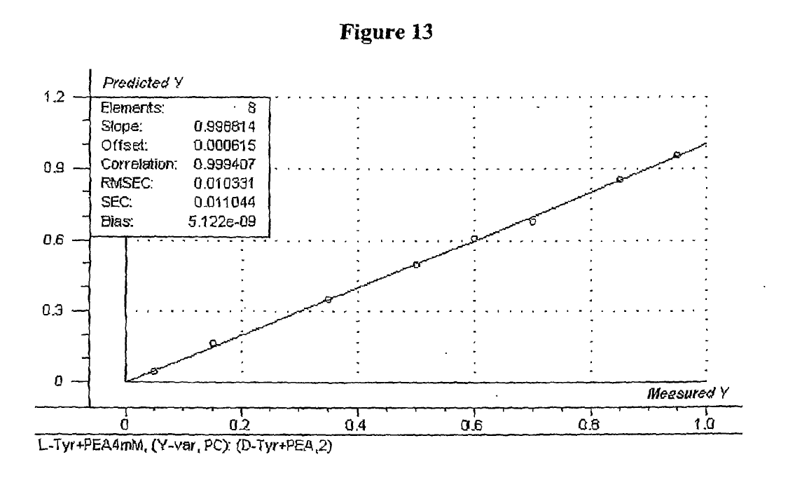

FIG. 13 shows the UV absorption spectra of 4 mM solutions the S-PD esterified D- and L-phenylalanine, which were reacted with the (S)-(+)-1,2-propanediol chiral discriminator in an in situ, acid catalyzed, Fischer esterification procedure described earlier. The mean centered spectra of these solutions are shown as a top right corner insert in FIG. 13. The mean centered spectra, which reveal the two solutions have different absorbances in the wavelength region shown, indicate that ester diastereomers of D- and L-Phe were formed in the esterification reaction with the S-PD chiral alcohol. The enantiomers of phenylalanine were, therefore, discriminated by (S)-(+)-1,2-propanediol.

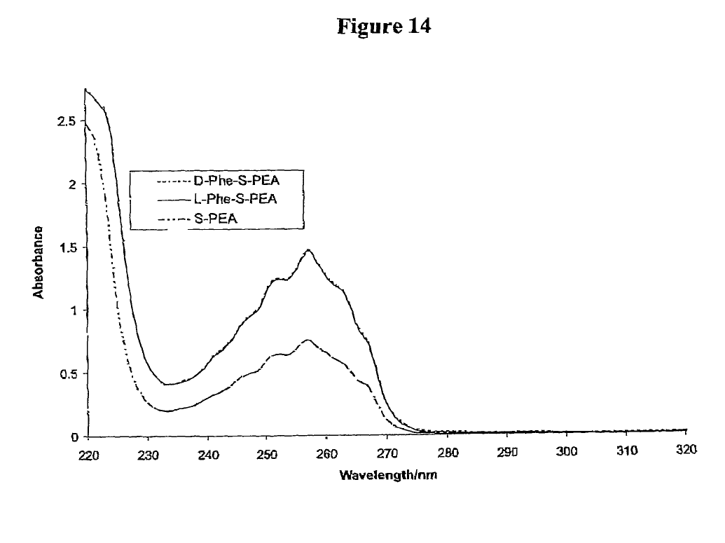

FIG. 14 shows the mean centered spectra of fifteen sample solutions prepared by mixing known weights of the 4 mM stock solutions of the S-PD esterified D- and L-phenylalanine. The sample solutions have identical total S-PD esterified phenylalanine concentrations but vary in their S-PD esterified D- and L-phenylalanine compositions. The insert is the original spectra of the fifteen sample solutions. Unlike the S-PEA analysis described above, the sample solutions prepared for this S-PD ester analysis were not varied at regular mole fraction intervals. The weight compositions of the samples were varied irregularly. As such, the mean centered spectra, at a first glance, seem not to have any order at all and would, therefore, seem to suggest the absence of correlation between enantiomeric composition and spectral data. The purpose for doing this is test the robustness and effectiveness of the ‘in situ enantiomeric diastereomerization’ technique as applied to esterification. Prior to modeling, the mole fractions of the samples were computed in terms of the recorded weights instead of the volume readings set on the eppendorf pipette used.

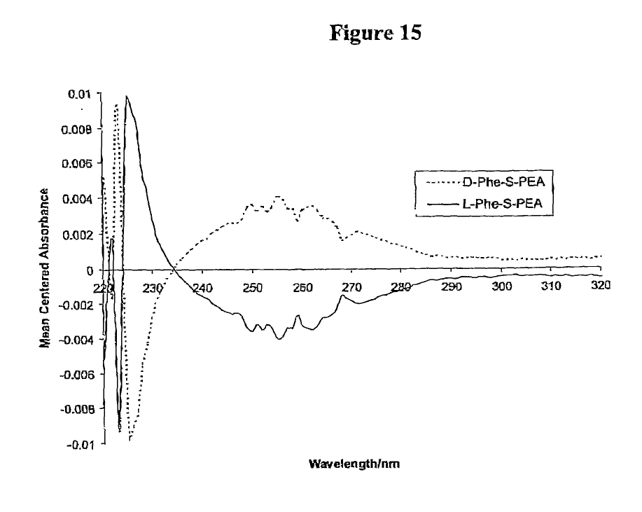

FIGS. 15A, B, C, and D show the PLS1 model plots of seven randomly selected calibration samples (0.0500, 0.150, 0.250, 0.300, 0.500, 0.750 and 0.950 in terms of D-Phe mole fractions). The scores plot (FIG. 15A), regression coefficient plot (FIG. 15B), and residual validation variance plot (FIG. 15C), have similar characteristics as those obtained in the use of (S)-(−)-1-phenylethylamine as a chiral discriminating agent. The explanations given for the nature of these plots in the S-PEA analysis, therefore, hold in this S-PD analysis. The calibration regression plot, shown in FIG. 15D, which summarizes the effectiveness of the analysis, has a slope of 0.999, a correlation coefficient of 0.999, an offset of 0.0004, for the regression line and a RMSEP of 0.009 for the prediction of the calibration samples. These statistics indicate a strong correlation of spectral data with enantiomeric composition of the calibration samples. To validate the calibration model in order to evaluate its robustness and ability to predict unknown samples, it was used to predict the enantiomeric compositions of eight independently prepared test/validation samples. The results of the prediction, shown in Table 4 below indicate an accurate prediction of the test samples. The RMSEP obtained is only 0.014. These outcomes strongly suggest that the discrimination strategy is as efficient as the use of (S)-(−)-1-phenylethylamine in which case a RMSEP of 0.012 was computed.

TABLE 4

| Actual mole | Predicted mole | Actual mole | Predicted mole |
|---|---|---|---|
| fraction of | fraction of | fraction of | fraction of |
| D-Phe | D-Phe | L-Phe | L-Phe |
| 0.103 | 0.0848 | 0.897 | 0.915 |
| 0.400 | 0.407 | 0.600 | 0.593 |
| 0.451 | 0.425 | 0.549 | 0.575 |
| 0.597 | 0.596 | 0.403 | 0.404 |
| missing | 0.773 | missing | 0.227 |
| 0.801 | 0.801 | 0.199 | 0.208 |
| 0.851 | 0.859 | 0.149 | 0.141 |
| missing | 0.877 | missing | 0.123 |

RMSEP for D-Phe and L-Phe = 0.014

### Example 6

### Comparison

Table 5 below is a summary of chiral selectors used in various methods of chiral analysis by regression modeling of spectral data.

TABLE 5

| Chiral selector | Analyte concentration | Prediction error (RMSEP) range |
|---|---|---|
| Cyclodextrins (CDs) | 3.75-15 mM | 0.02-0.10 |
| Modified cyclodextrins (MCDs) | 7.5 mM | 0.05-0.6 |
| Chiral surfactants (CSs) | 1.0 × 10⁻⁴ − 5.0 × 10⁻⁶mM | 0.02-0.05 |
| 1.5-6% | | |
| Chiral ionic liquids (CILs) | 5 mM | 0.05-0.09 |
| 30 and 150 mM | | |

Analyte to selector (CDs and MDCs) mole ratio is 1:2
Chiral analytes include amino acids, pharmaceuticals and other organics

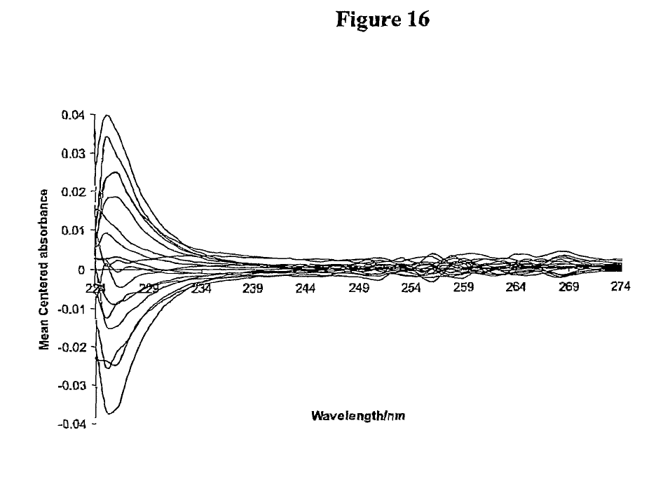

FIG. 16 compares the merits of the chiral discrimination strategies in terms of root-mean-squares error of prediction. The lower RMSEP limit, upper RMSEP limit and the difference in RMSEP (from left to right) for each chiral selector are shown as bars with the corresponding error values. Chiral selectors and chiral discrimination strategies with wide ranges of error are less precise and vise versa with respect to the class of compounds analyzed. On the other hand, chiral selectors and chiral discrimination strategies with both narrow error ranges as well as low lower and upper RMSEP values are both precise and more accurate with respect to the class of compounds analyzed. On the basis of this interpretation, the current discrimination strategy utilizing non-transient ionic or hydrogen bonding or covalent diastereomerization with S-PEA and S-PD has by far outperformed the other strategies for the analysis of the appropriate analytes.

### Example 7

### Concentration Effects

The selection of an appropriate concentration in these analyses can be done by determining the concentration at which the difference in spectra, in terms of intensity or shift in wavelength, of the solutions of a pair of diastereomerized enantiomers, is greater than the given instrument error. To ensure that the observed difference is a true value, measurements will have to be made for at least five replicates and for each replicate the difference must be at least 1.5 times the instrumental error in that measurement (absorbance or resolution in wavelength).

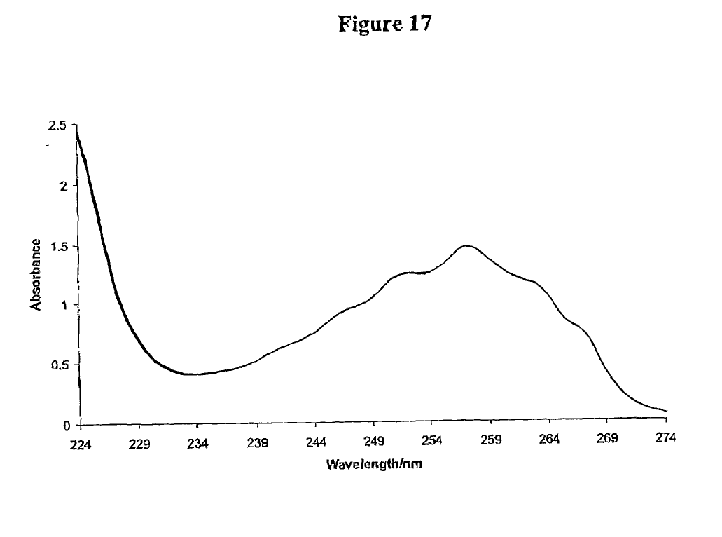

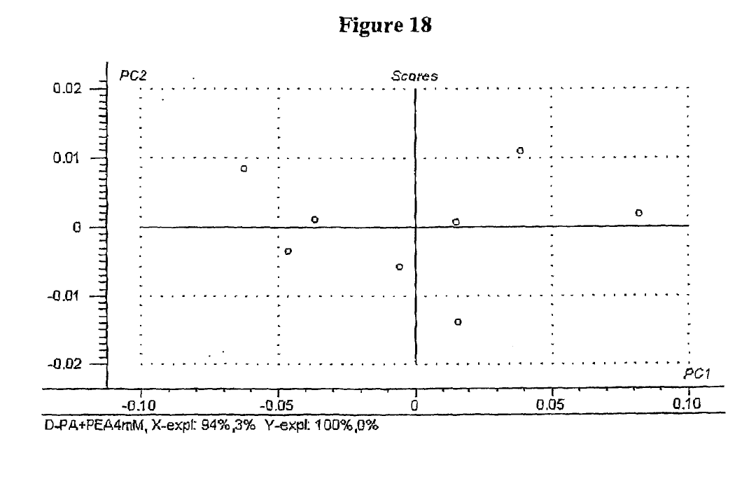

An example involves the analysis of arabinose. Arabinose is an aldopentose sugar with four hydroxy groups. Like any other monosaccharide, arabinose forms hydrogen bonds with water molecules in aqueous medium. In a dilute solution containing D- and L-Arabinose and S-PEA, interaction between arabinose and S-PEA molecules is limited by the interaction of water molecules, which are polar, with arabinose. Enantiomeric discrimination under conditions like this are ineffective. FIG. 17(A) shows the UV spectra of 3 mM solutions of D- and L-Arabinose prepared by dissolving appropriate amounts of D- and L-Arabinose in 3 mM S-PEA solution. FIG. 17(B) shows the spectra of 12 mM solutions of D- and L-Arabinose prepared by dissolving appropriate amounts of D- and L-Arabinose in 6 mM S-PEA solution. These figures show the important effect of concentration on the discrimination of D- and L-Arabinose by S-PEA. FIGS. 18(A) and (B) show the UV spectra of 3 and 12 mM sample solutions made up of different compositions of D and L-Arabinose solutions prepared by dissolving appropriate amounts of D- and L-Arabinose in 3 and 6 mM S-PEA solutions respectively. Note the effect of concentration on the differences in spectra of the different compositions of D- and L-Arabinose created by S-PEA in FIGS. 18(A) and (B). FIG. 18(A) shows the spectra of twelve samples and FIG. 18(B) shows thirteen samples.

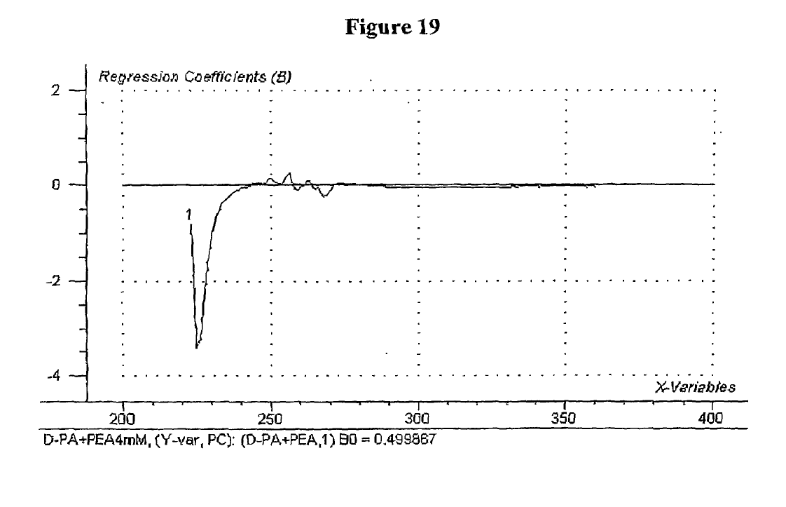

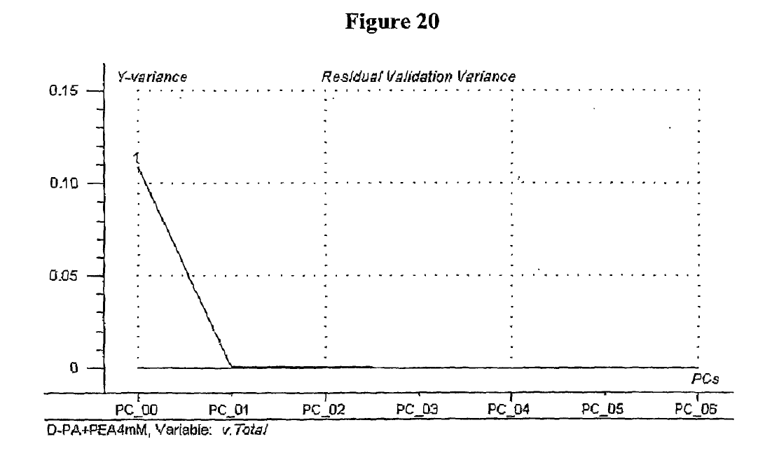

FIG. 19 shows the PLS-1 regression validation plots of the twelve sample solutions shown in FIG. 18(A). The presence of noise in the regression coefficient plot indicates less distinction between samples and the high root-mean-square error of prediction (“RMSEP”) indicates weak predictability at the 3 mM concentration level. FIG. 20 shows the PLS-1 regression validation plots of the thirteen samples solutions shown in FIG. 18(B). The absence of noise in the regression coefficient plot indicates high distinction between samples, and the lower root-mean-square error of prediction (“RMSEP”) indicates strong predictability at the 12 mM concentration level, compared with that in FIG. 19.

The results of this example show that enantiomeric composition analysis of arabinose at a concentration of 3 mM produced high error in correlation of spectral data with enantiomeric composition. A four fold increase of the concentration (12 mM), however, resulted in a lower error in correlation of spectral data with enantiomeric composition. This is because at the higher concentration, the interaction was much stronger due to the molecules being closer together. This improved the discrimination and resulted in a greater difference in spectra between D- and L-Arabinose.

### Example 8

### Chromophore Effects

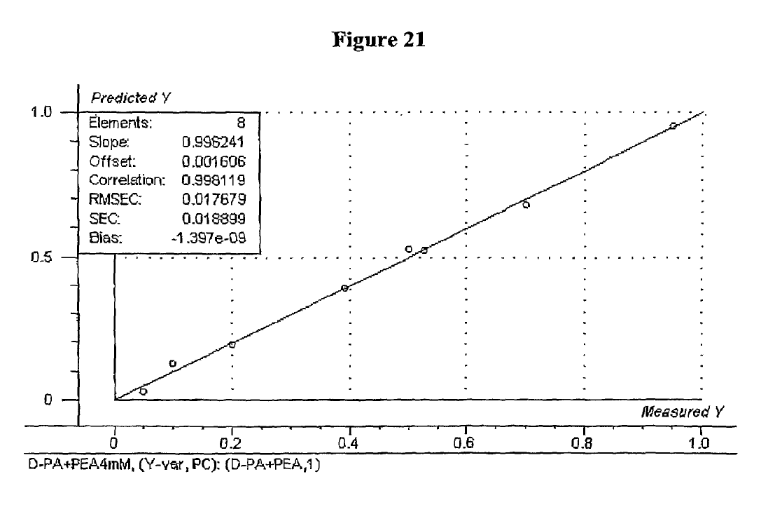

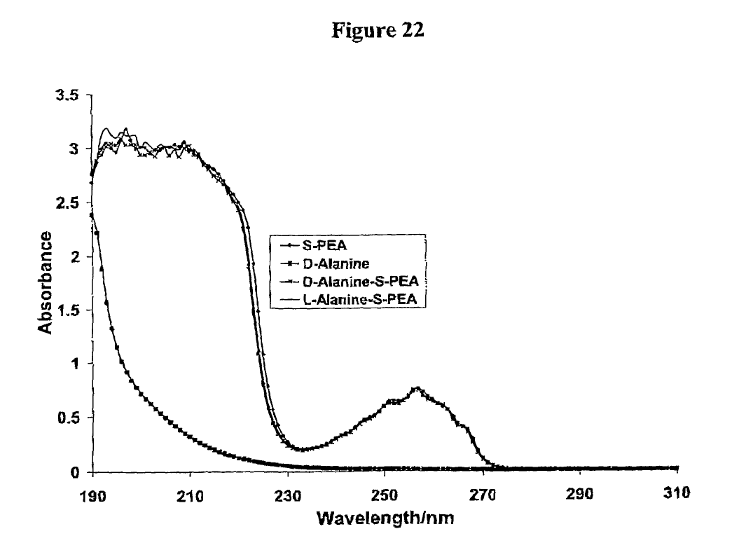

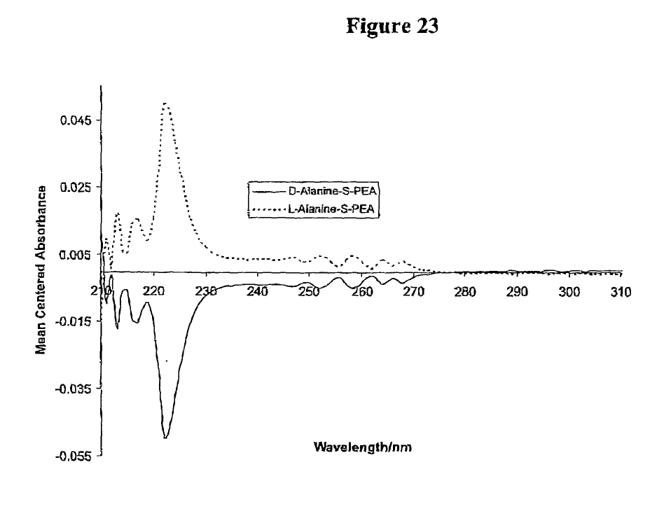

FIG. 21 shows the UV absorption spectra of 4 mM (A) and 20 mM (B) solutions of D- and L-Alanine esters of S-1,2-propanediol. The absence of difference in spectra at both concentration levels despite the large difference indicates insensitivity due to the absence of a sensitive chromophore. FIG. 22 shows PLS-1 regression validation plots of fifteen sample solutions of different compositions of 4 mM D- and L-Alanine esters of S-1,2-propanediol. There is poor correlation (an almost flat regression line) of true spectral information (i.e., a noiseless regression coefficient plot) with enantiomeric composition and the RMSEP is very high (˜50%). FIG. 23 shows regression validation plots of thirteen sample solutions of different compositions of 20 mM D- and L-Alanine esters of S-1,2-propanediol. Again, there is poor correlation (0.79) of spectral information with enantiomeric composition and the RMSEP (˜19%) is high. The 20 mM plots show some improvement in correlation of spectral data with enantiomeric composition at 20 mM rather than that shown in FIG. 22. These results imply that higher concentration of alanine is required for a successful analysis. On the other hand, a chiral alcohol like phenylethanol, which has a strong UV absorbing chromophore can be employed.

As shown already in the results of the analysis of alanine with S-1-PEA, a concentration of 4 mM was enough to successfully correlate spectral data with enantiomeric composition for enantiomeric composition analysis of alanine. These results indicate that apart from the need to form diastereomeric pairs, the presence of chromophores, which is considerable sensitive to the probing technique and can spectrally communicate the difference between enantiomeric pairs, is important.

### Example 9

### Nature of Interactions Between Chiral Selector and Chiral Analyte

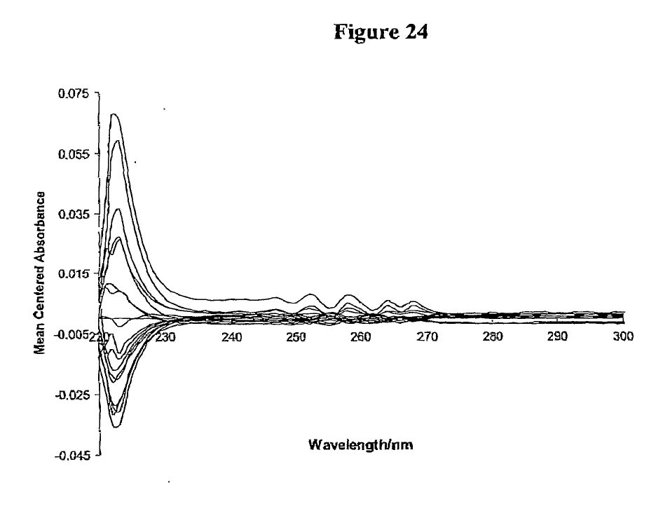

Without wanting to be bound by theory, two possibly predominant modes of interaction, ion pair electrostatic attraction and hydrogen bonding, in addition to aromatic π-system interactions, can be attributed to the enantiomeric discriminations observed in the use of S-1-PEA for enantiomeric composition and enantiomeric excess analysis. To demonstrate that the first mode of interaction is the most likely to be encounted with analytes containing carboxylic acid groups (—COOH), an interaction study, monitored with UV spectroscopy, was conducted between acetic acid and S-1-PEA. The experimental results are shown in FIG. 24. This figure shows the spectral results of aqueous solutions of: (1) a 1:1 (0.45 mL:0.45 mL) equimolar (6 mM) acetic acid (—COOH functional group) and S-1-PEA (—NH₂ and phenyl functional groups), (2) 6 mM S-1-PEA, (3) 6 mM acetic acid, and (4) 0.45 mL of 6 mM S-1-PEA diluted with 0.45 mL deionized water to give a 3 mM solution. The spectra of the 3 mM solution was recorded as a control in order to determine the effect of dilution on the spectrum of S-1-PEA. It was therefore important in determining the true mode of interaction, based on its effect compared to that of acetic acid, on the spectrum of the 6 mM S-1-PEA solution.

Comparing the spectrum of the 1:1 equimolar solution with that of the diluted S-1-PEA, a large hypsochromic effect (7 nm shift) can be seen in the spectrum of the 1:1 equimolar solution. This shift is measured from the valley (233 nm) of the spectrum of the diluted S-1-PEA solution to that of the 1:1 equimolar solution at 226 nm. In addition, a blue shift of 1 nm is evident in the peak position, from 257 nm (diluted S-1-PEA) to 256 nm (1:1 equimolar solution). On the other hand, a careful comparison of the spectrum of the diluted solution to that of the original 6 mM S-1-PEA solution reveals no wavelength shifts. An expected decrease in intensity, however, is evident. Based on the literature available on the properties of these compounds, it is likely that the difference in acid-base behavior of these species accounts for the observed results. With the large difference in pka value between acetic acid (4.7: —COOH group) and S-1-PEA (9.83: —NH₃⁺), these substances will react with each other as a Bronsted-Lowry or Lewis acid-base pair. This will result in the formation of a quaternary ammonium cation of S-1-PEA and a carboxyl anion of the acetic acid. The two chemical species will therefore interact with each other, in solution, through ion pair electrostatic attraction. With the protonation of the amine group of S-1-PEA, the lone-pair electrons, originally available on the nitrogen, which could participate in possible hyperconjugation between the aromatic n-system of the phenyl group and the hydrogen bonded to the stereogenic carbon, would become localized in the coordinate bond between the nitrogen and the proton, which is donated by the acetic acid. This effect will increase instead of decrease the π→π* transition energy of the aromatic system of S-1-PEA. As such the forbidden A_{1g}→B₂ᵤ (˜255 nm) and A_{1g}→B₁ᵤ (˜203.5 nm) transition energies of benzene ring, originally possibly lowered by hyperconjugation and lone-pair electron participation, due to hydrogen substitution in benzene by ˜CHCH₃NH₂ to form S-1-PEA, are blue shifted. The spectral results therefore represent the possible changes in spectra of the S-1-PEA chiral selector when it interacts through ion pair formation (ion pair electrostatic attraction) with chiral analytes having carboxylic acid functional groups

A comparison of the results of the acetic acid-S-1-PEA interaction experiment with the interaction experiments carried out using alanine, phenylalanine, and tyrosine, each of which contains a —COOH group, reveals quite a different outcome. Unlike acetic acid, these amino acids have amine groups with ka values of the same order as that of S-1-PEA. In aqueous solution, these amino acids exist as neutral species known as zwitterions. The zwitterions are formed by intramolecular proton transfer, where protons from the —COOH group, on ionizing in water, are transferred to the amine group of the amino acid. With similar pka values between these amino acids and S-1-PEA, complete protation of the amine group of S-1-PEA by intermolecular proton transfer, leading to coordinate bond formation, is unlikely. This is unlike the situation with acetic acid. Instead, the amine groups of both the amino acid and the S-1-PEA would most probably tend to associate with the proton from the —COOH group through weak electrostatic attractions. On the basis of this similarity between the amine groups of the amino acids and S-1-PEA, it is possible that the proton is switching position between the amine group of the amino acid and that of the chiral selector (S-1-PEA). The protonated amine group, hybrid or canonical structures can therefore be drawn for the amino acid-S-1-PEA interaction. It is likely that a resonance structure in which the proton is positioned between the amine groups of the two molecules is formed in solution. This resonance structure is the possible diastereomeric structure formed in solution through electrostatic attraction. On the basis of this, less than a complete or transient zwitterion should be formed by the amino acid and less than a completely protonated S-1-PEA species should be formed by S-1-PEA. Under this condition the difference in spectral features of S-1-PEA in solutions containing both the amino acid and S-1-PEA, compared to a solution containing only S-1-PEA, is not expected to be dramatic. This is because the situation with the amino acid-S-1-PEA system, where the amino acid has no other functional group capable of reacting with S-1-PEA, apart from the presence of a —COOH and an —NH₂ group, is not expected to be much different from the unassociated or the amino acid-free state of S-1-PEA. In addition, the groups involved in and the nature of the electrostatic attraction are different from those of the acetic acid-S-1-PEA system. Therefore, differences in the extent of the effect of the electrostatic attraction are expected.

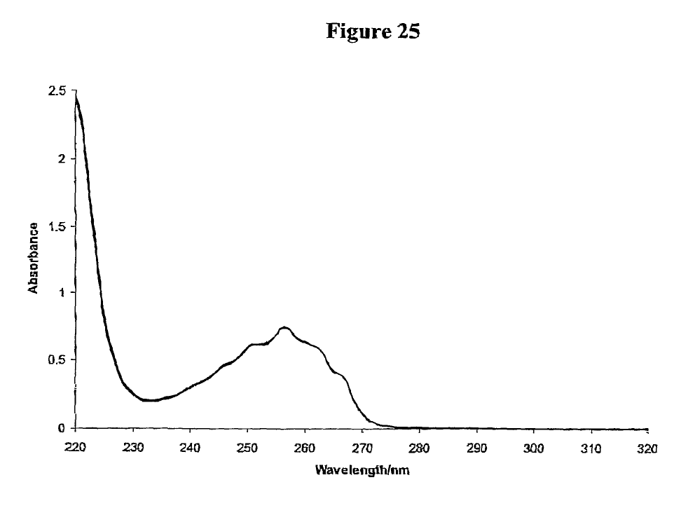

The spectral results of the S-1-PEA interaction experiments for alanine and phenylalanine, which have no other functional groups, unlike the —OH in tyrosine, for possible interaction with S-1-PEA, appear to confirm these predictions. No dramatic changes in spectral features are observed as can be seen for acetic acid. The results for alanine are shown in FIG. 25. It is evident from the figure that the spectrum of the 1:1 equimolar (6 mM) aqueous solution of alanine and S-1-PEA, compared with that of 6 mM S-1-PEA solution, which was diluted with an identical volume of deionized water (to reduce the concentration to 3 mM), is shifted to shorter wavelengths. The shift in the peak position, from 257 nm to 256 nm, is identical to that observed for acetic acid. The blue shift recorded for the valley (233 nm) is, however, just a nanometer (233 nm to 222 nm), compared to the 7 nm blue shift recorded for acetic acid. On the basis of these results, it can be inferred that the interaction between analine and S-1-PEA and its effect on the spectrum of S-1-PEA, is identical in nature to that between acetic acid and S-1-PEA. The wavelength shift, 233 nm to 222 nm of the valley observed for analine, however, indicates that the extent or magnitude of the interaction is smaller compared to that of the acetic acid

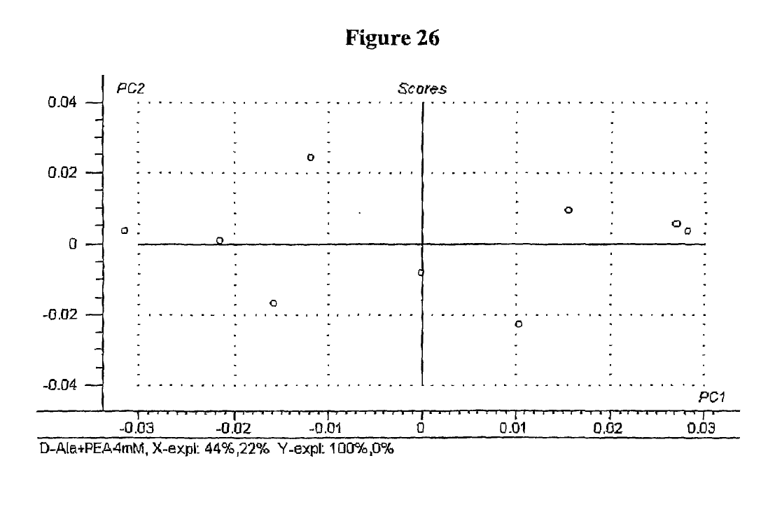

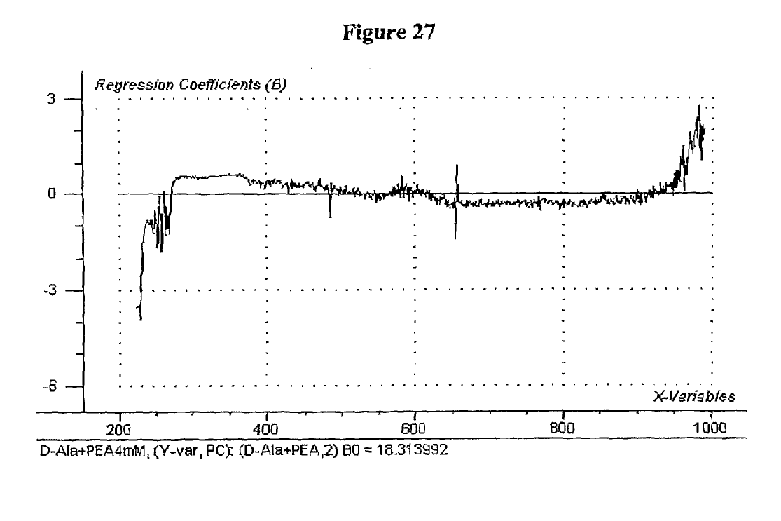

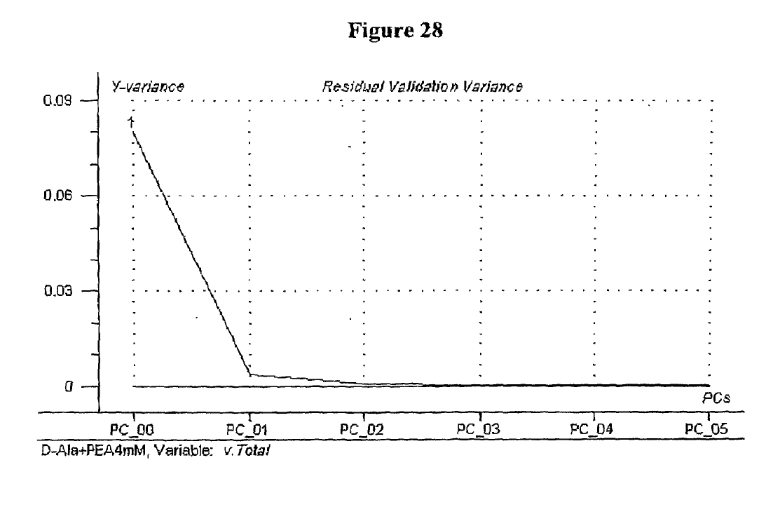

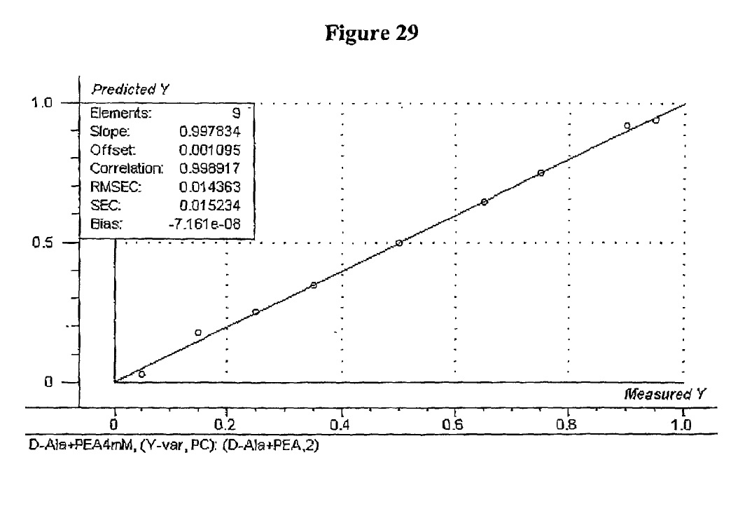

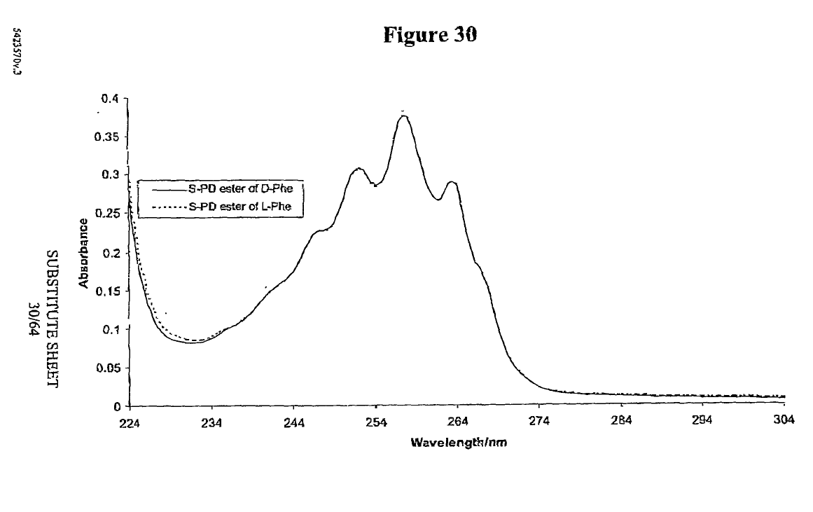

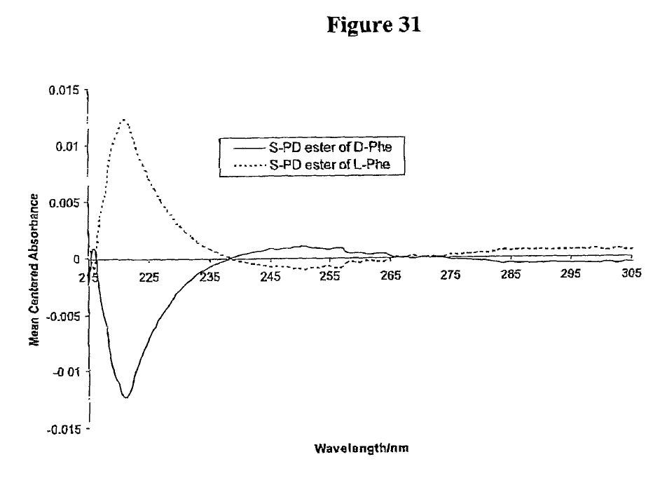

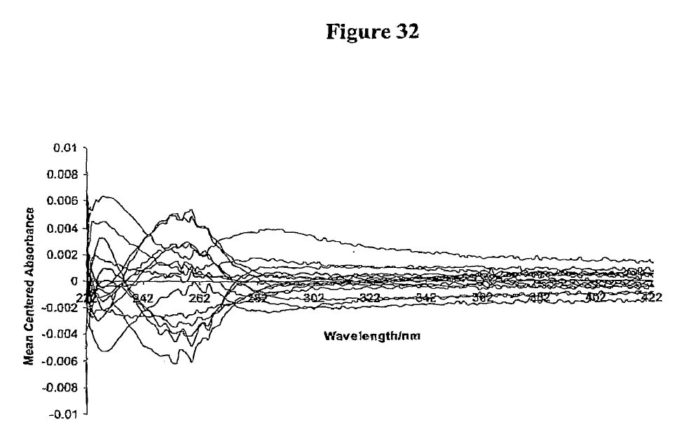

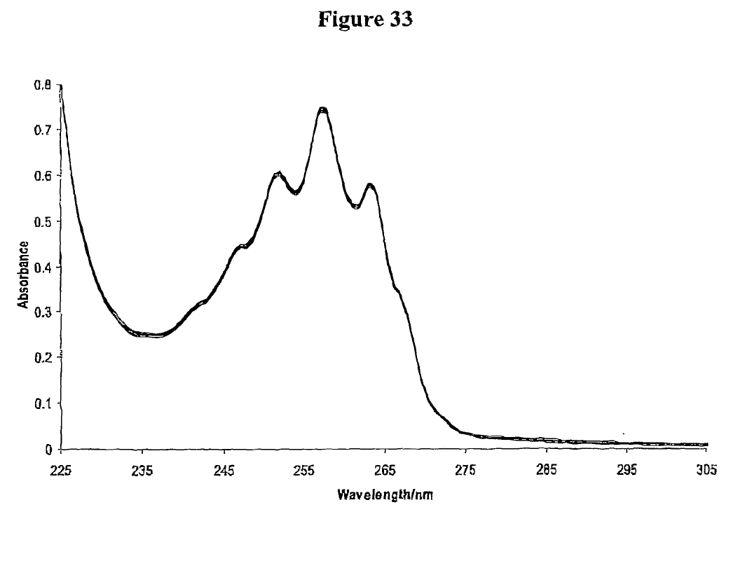

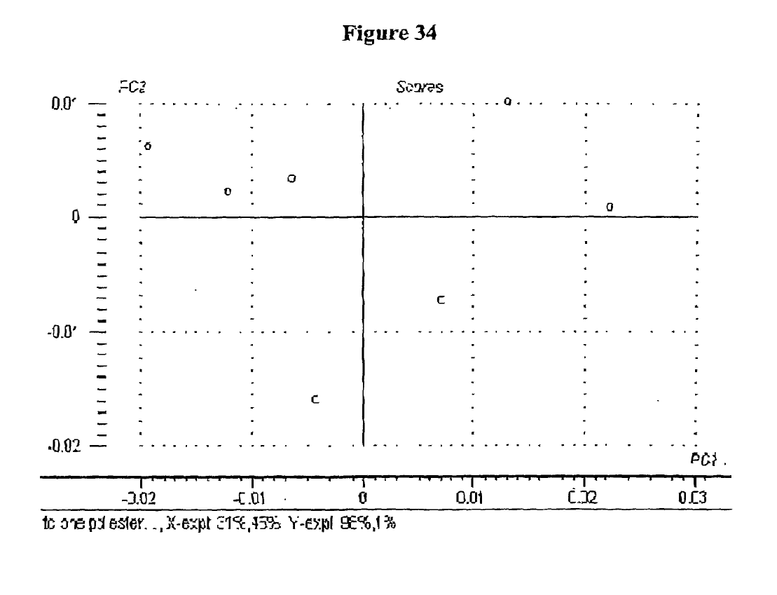

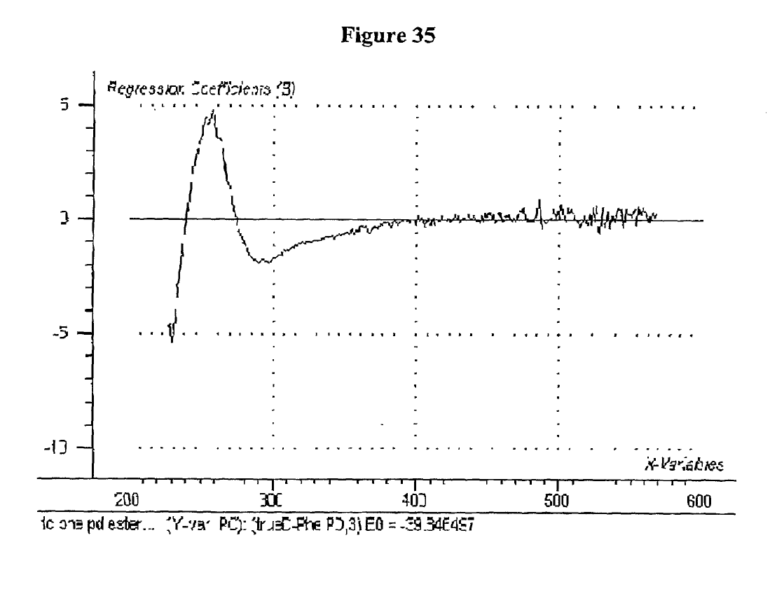

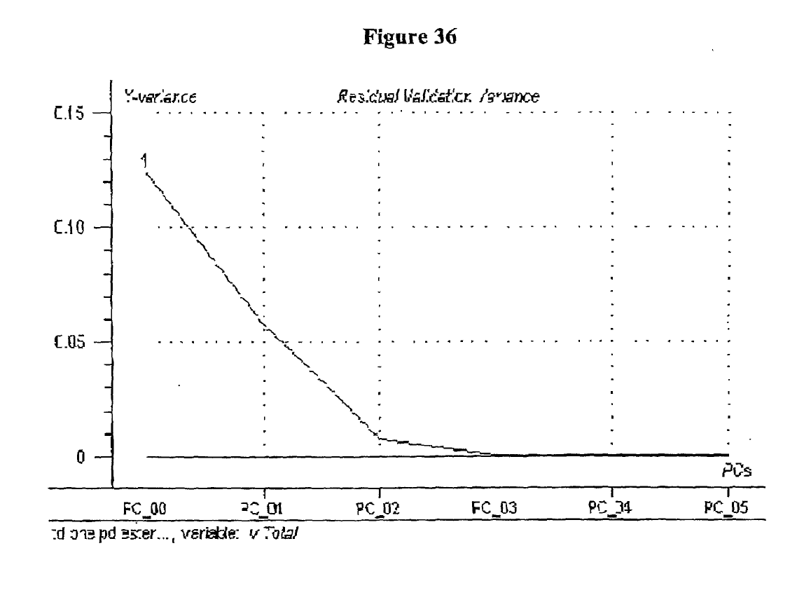

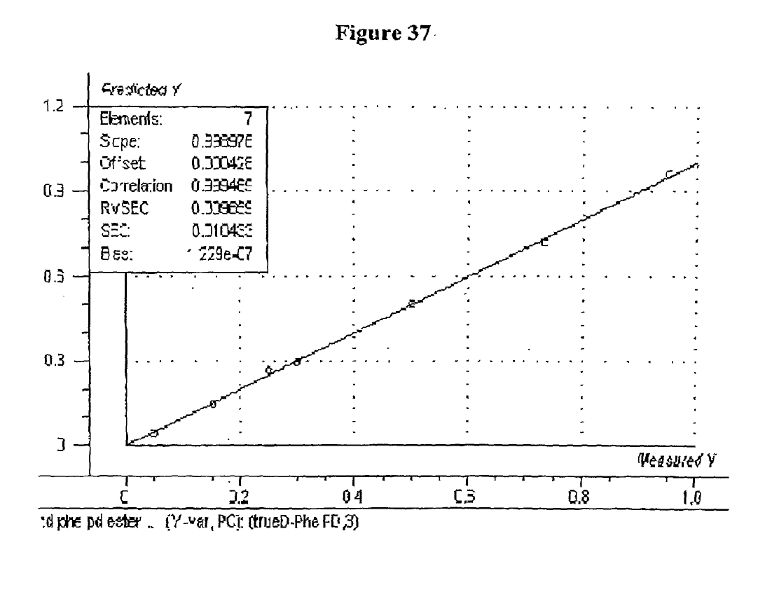

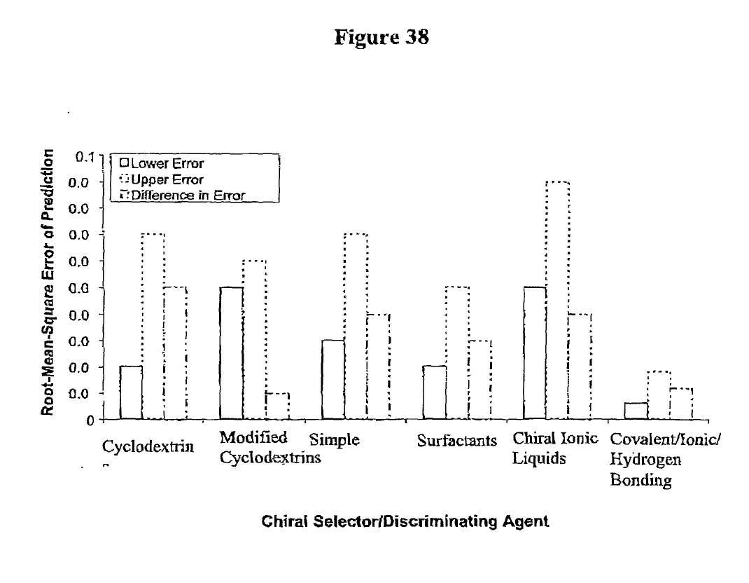

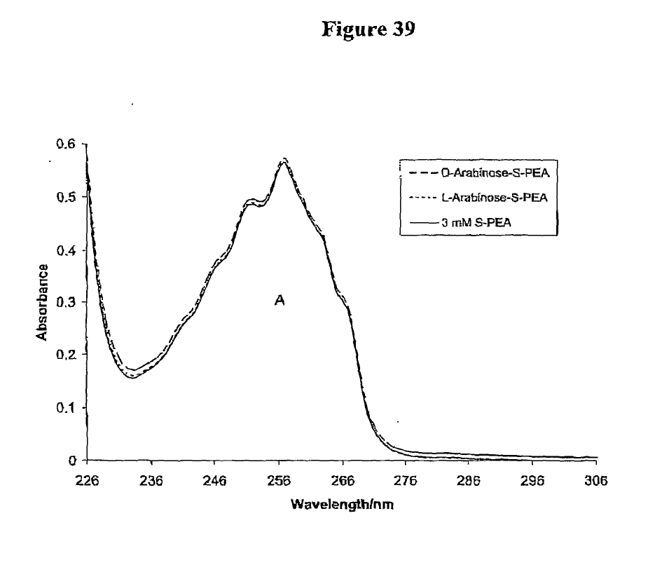

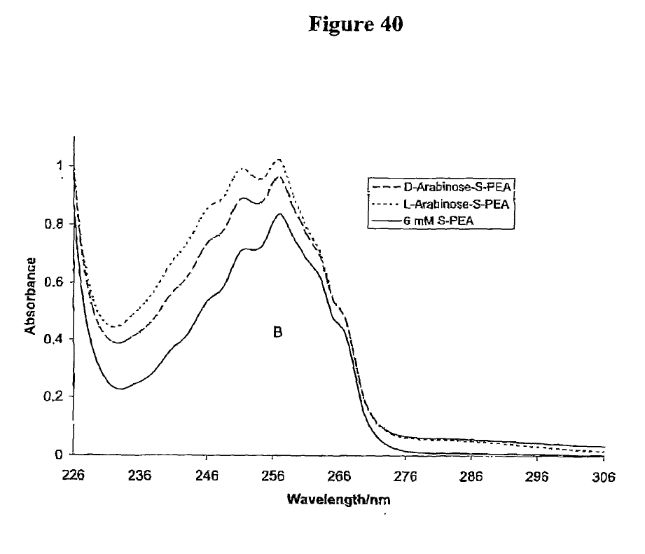

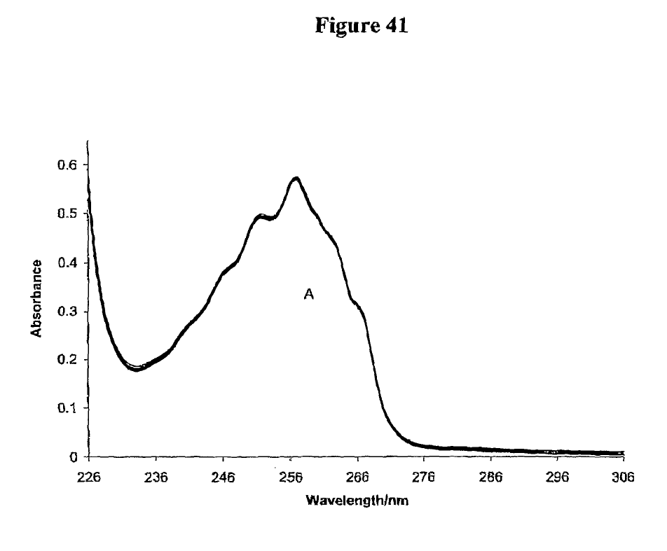

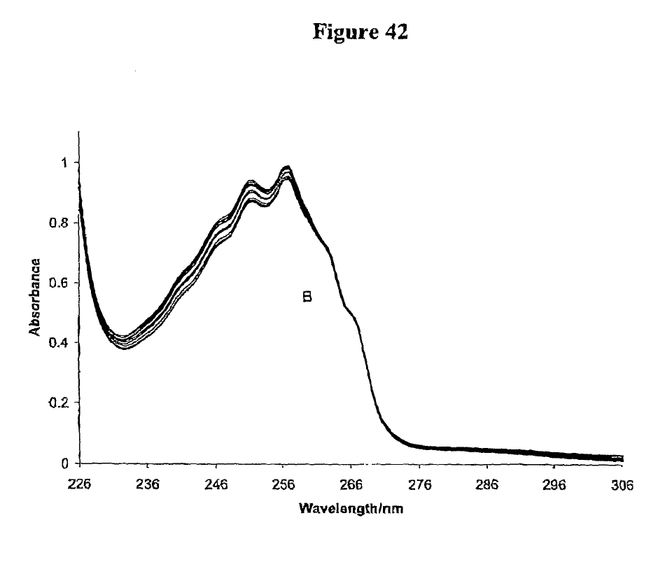

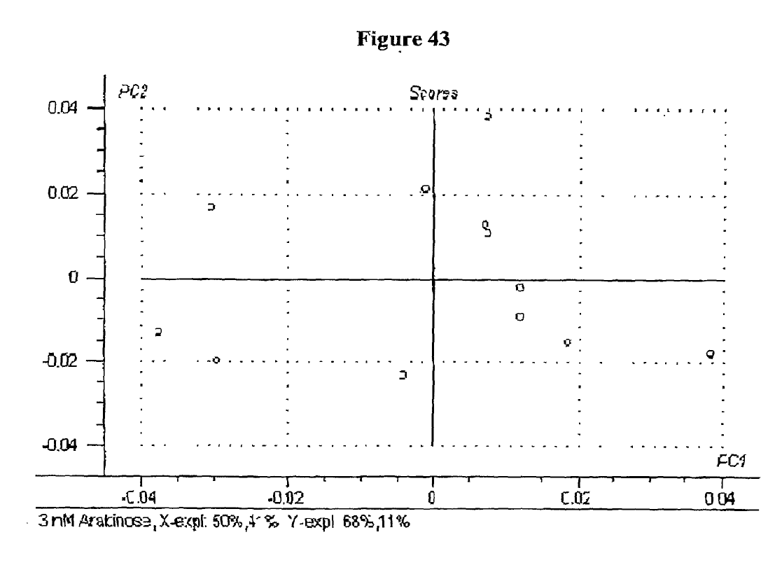

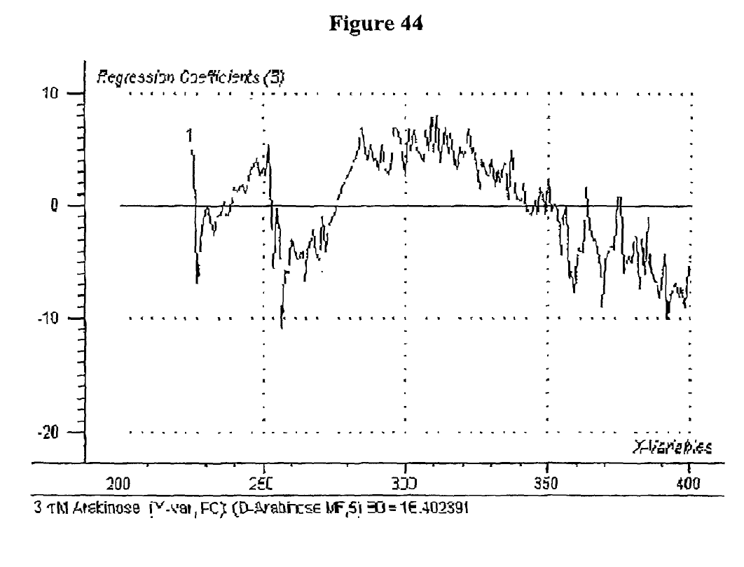

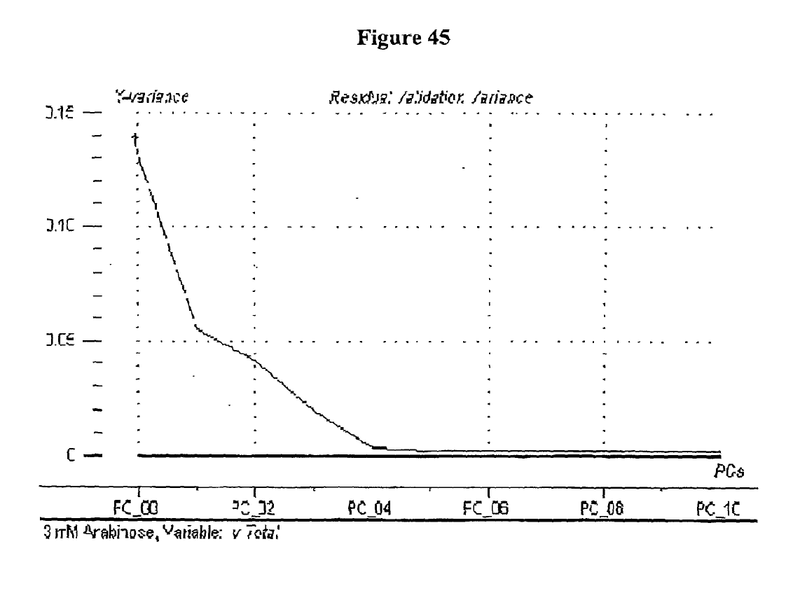

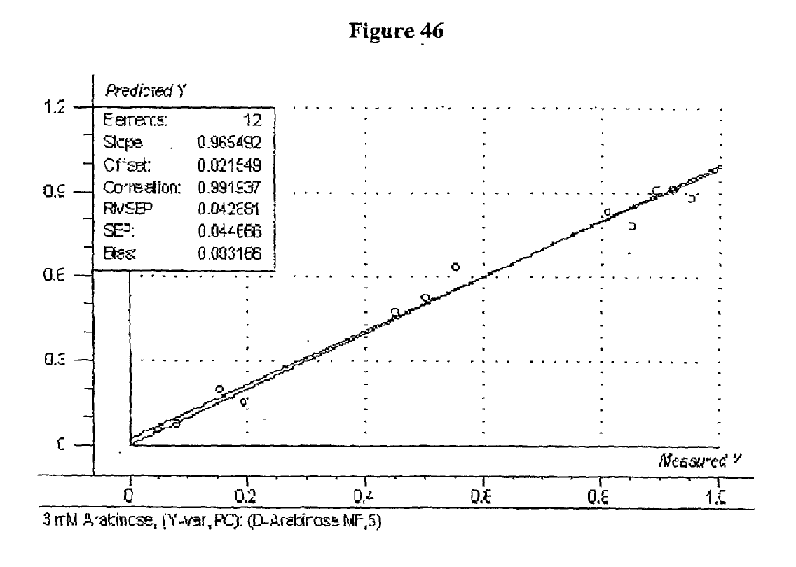

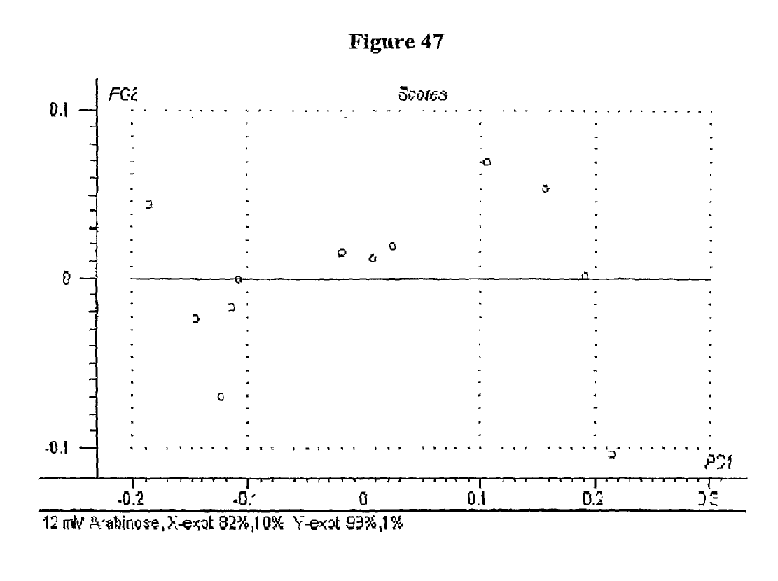

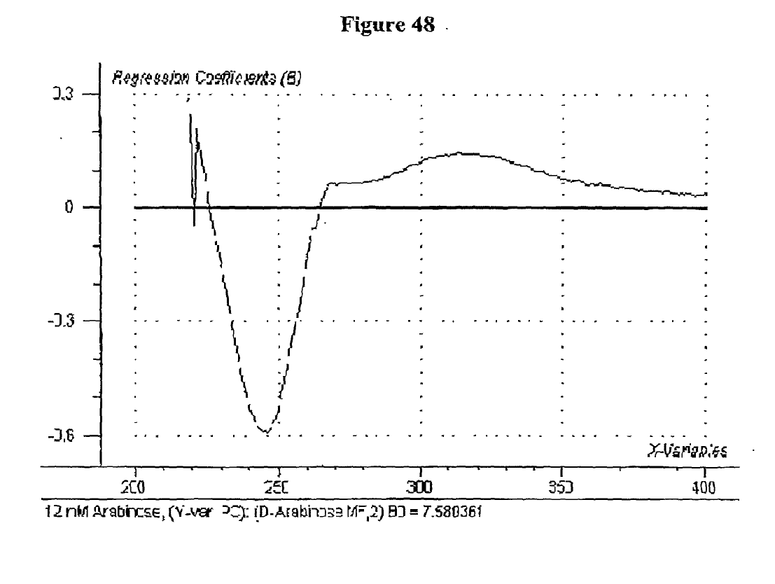

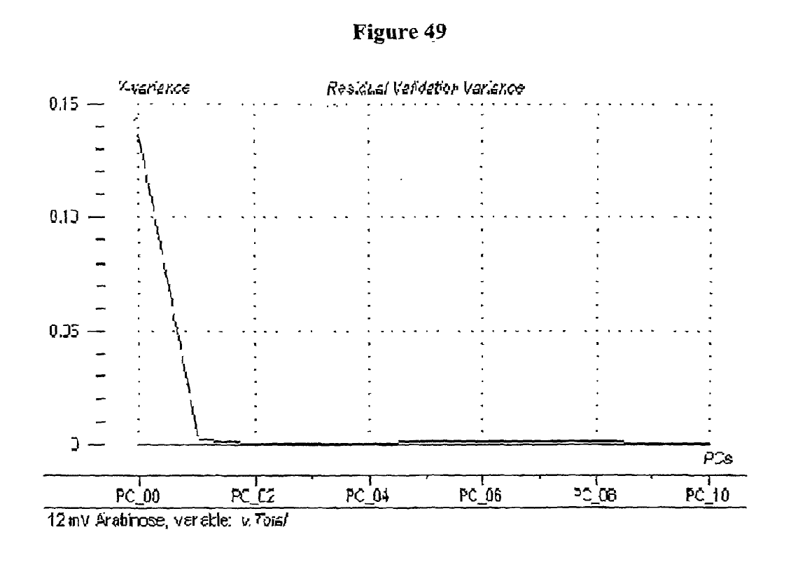

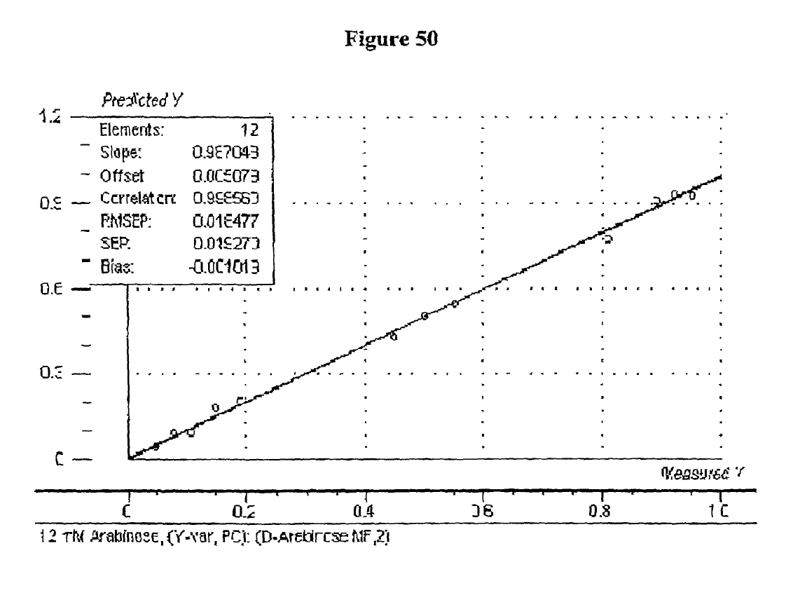

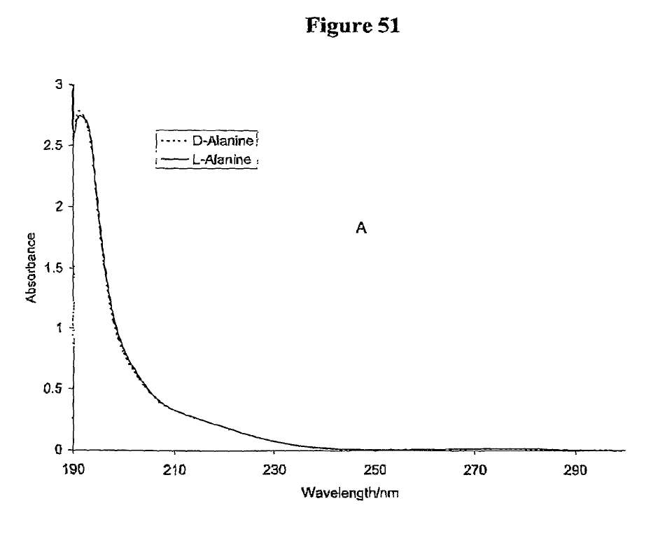

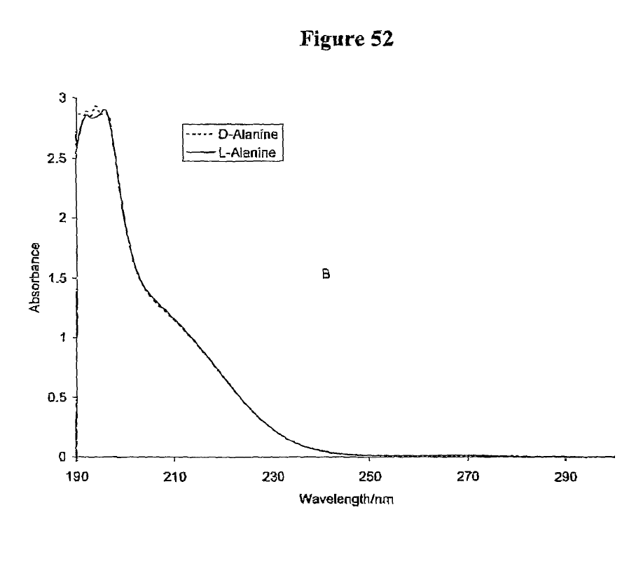

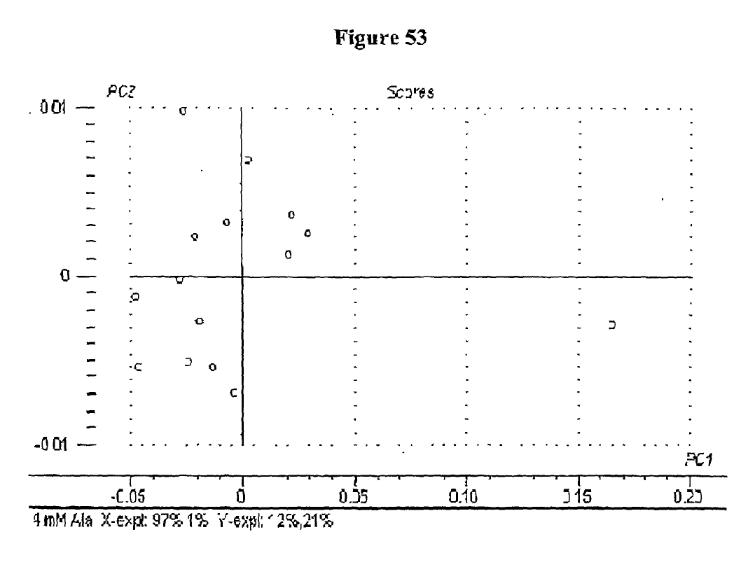

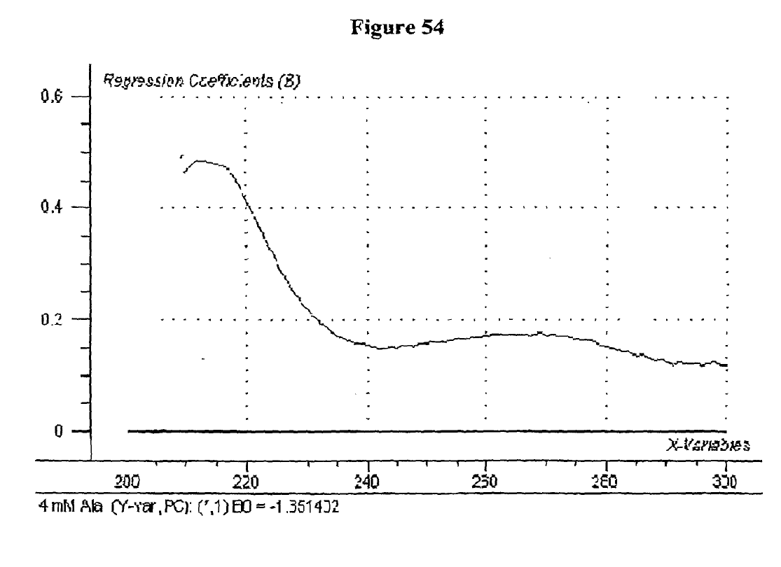

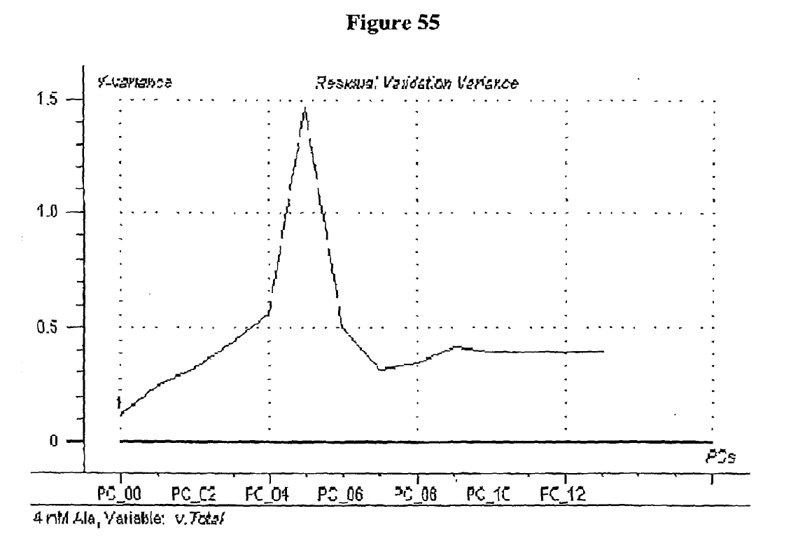

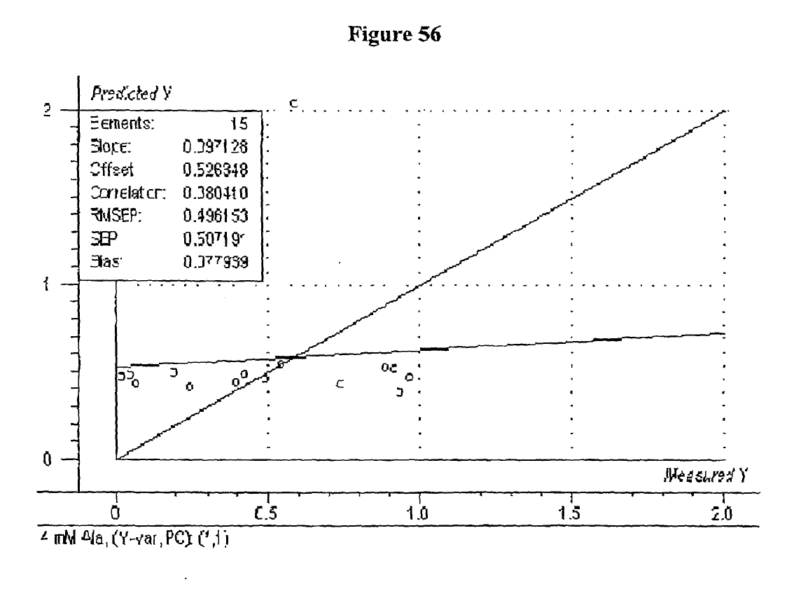

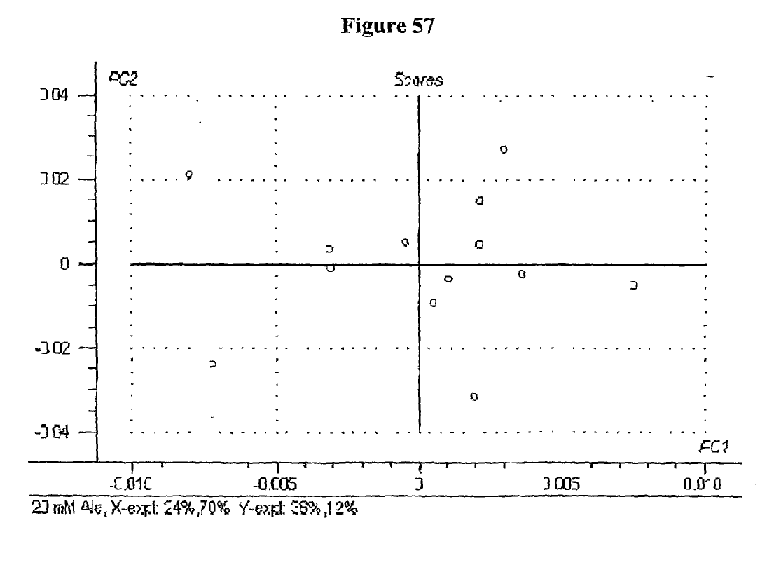

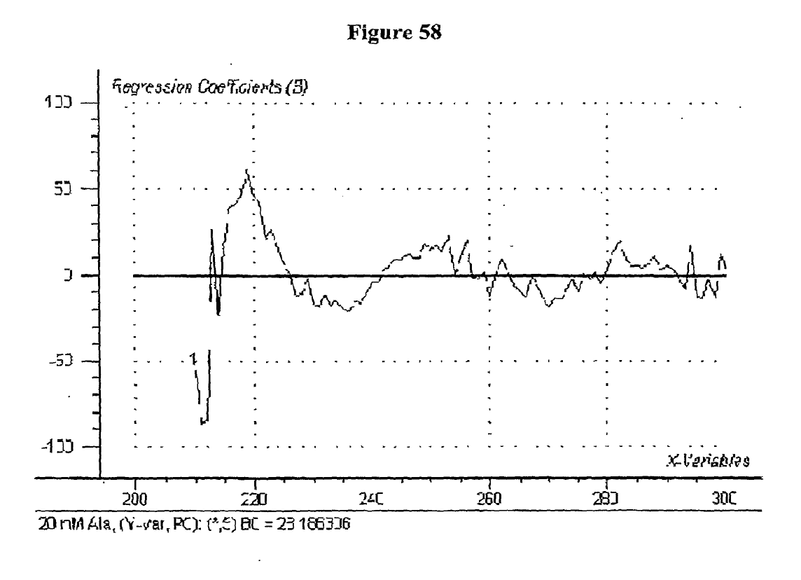

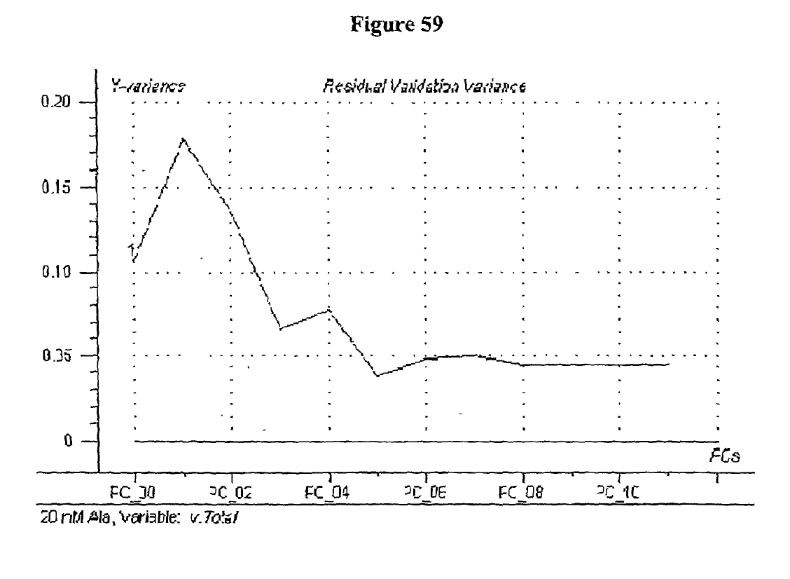

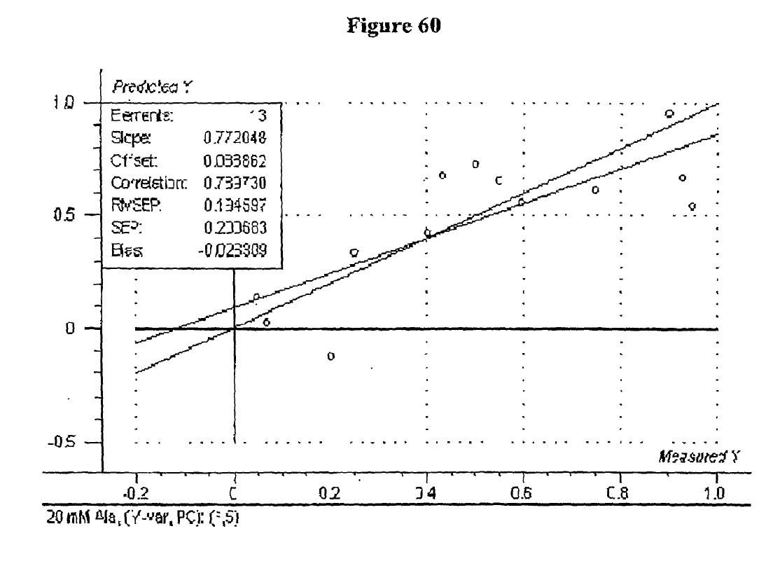

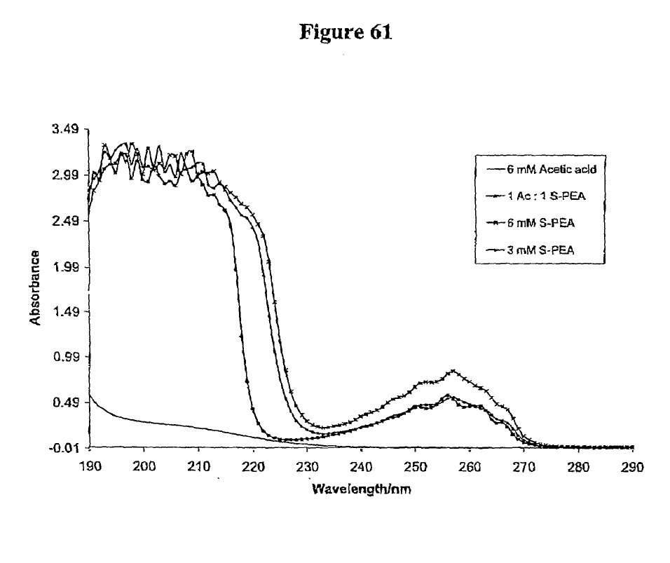

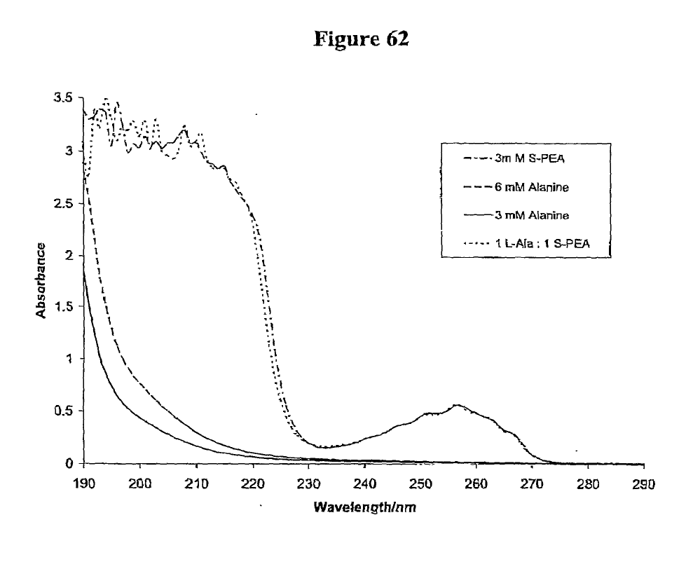

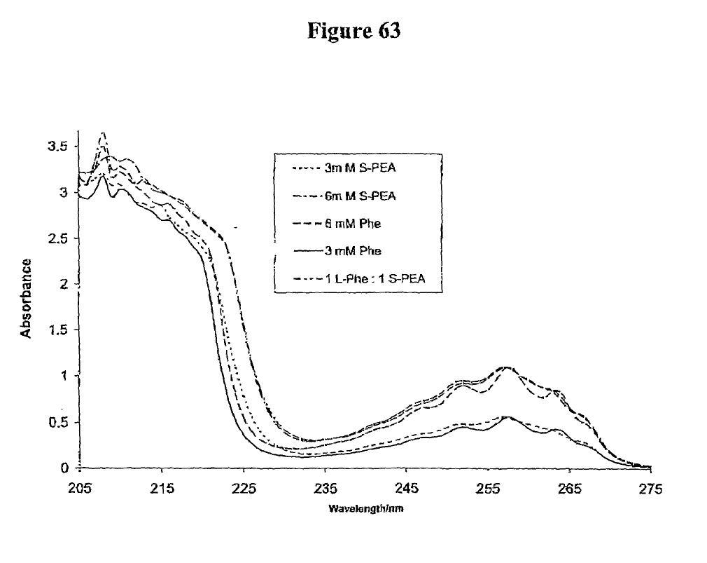

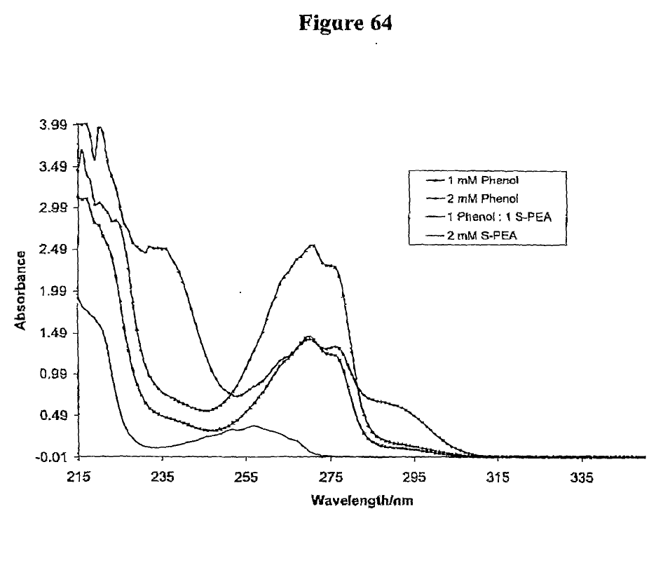

Phenylalanine is considered to interact with S-1-PEA through its amine group just as alanine does. Unlike alanine, phenylalanine has a phenyl side chain, which can participate in aromatic π-system interactions with S-1-PEA in addition to the electrostatic interaction proposed above. Changes in the spectrum of S-1-PEA as a result of the interplay of these modes of interaction were therefore considered. FIG. 26 shows the spectral results of the interaction experiment of phenylalanine (Phe) with S-1-PEA. FIG. 27 shows the UV spectra of aqueous solutions of 6 mM L-Phenylalanine (Phe), 6 mM S-1-PEA, 1:1 equimolar (6 mM) mixture of Phe and S-1-PEA, 3 mM Phe and 3 mM of S-1-PEA. The 3 mM solutions were prepared by diluting the 6 mM solutions with volumes of deionized water equal to the volume of S-1-PEA solution used to prepare the 1:1 equimolar solution.

A careful comparison of the spectrum of the 1:1 equimolar aqueous solution of Phe and S-1-PEA with that of S-1-PEA, diluted with an equal volume of deionized water to prepare 3 mM Phe solution, shows a large increase in absorbance. The spectral band (shape of absorbance curve), in the region 224-290 nm, looks much like that of 6 mM S-1-PEA solution. In addition, the peak absorbance at 257 nm is similar to that of both the 6 mM S-1-PEA and 6 mM Phe solutions. Furthermore, the sum of the absorbance values of 3 mM aqueous solutions of Phe and S-1-PEA is ˜1.129 (0.0569 and 0.0560 respectively), which is not significantly different from the absorbance, 1.10, of the 1:1 equimolar solution of Phe and S-1-PEA. This indicates that, in the equimolar solution, Phe and S-1-PEA behave like independent species absorbing UV radiation at similar wavelengths. A similar observation can be made in FIG. 26 in which the alanine-S-1-PEA equimolar solution gave an absorption spectrum which, except for the hypsochromic shifts from 233 nm to 222 nm and 257 nm to 256 nm, is similar in shape to the S-1-PEA solution diluted with the an identical volume of water. This buttresses the conclusion that because of the weaker nature of the amine-proton-amine (—NH₂—H⁺—NH₂—) electrostatic interaction, compared to the much stronger carboxyl anion-quarternary amine cation (—COO⁻—NH₃⁺) interaction of acetic acid with S-1-PEA, less dramatic changes in spectral features are expected.

Just as it is evident from the spectrum of the alanine-S-1-PEA equimolar solution, significant differences can be seen in the spectrum of the Phe-S-1-PEA equimolar solution. Unlike alanine, a careful examination reveals a 1 nm red shift (233 nm to 234 nm) in the valley of the spectrum of the Phe-S-1-PEA equimolar solution compared to the spectrum of the 6 mM S-1-PEA solution. In addition, higher intensities were recorded. These differences indicate that the two species were not entirely independent in solution but did interact. Comparing Phe to alanine, Phe has a phenyl side chain which is absent in alanine. This phenyl side chain can interact with the phenyl group of the chiral resolving agent (S-1-PEA) through aromatic π-system interaction. The aromatic systems (phenyl groups) in both of these compounds are connected by single bonds. This can allow the phenyl groups to assume different orientations relative to one another. Steric restrictions posed by groups connected to the atoms, which are singly bonded to the phenyl groups, will, however, determine the most favorable orientation. According to the literature, three types of low energy interaction conformations possibly exist between pairs of benzene molecules. These are the edge-to-face, face-to-face and parallel displaced interaction conformations. These interactions are noted to occur mainly by van de Waals dispersion and electrostatic interactions. Of these three, empirical evidence points to the edge-to-face interaction conformer to be of the lowest energy (true ground state). As reported in the literature, these interactions are involved in DNA stabilization, drug interactions, protein structure, and supramolecular chemistry (Burley et al. 1985). It is therefore not far fetched and impracticable for the Phe-S-1-PEA system to interact through their phenyl groups.

The UV spectrum of the 1:1 Phe-S-1-PEA solution compared with the spectrum of the 6 mM solution of Phe clearly confirms this. The broad but observable vibrational structures (252 nm, 257.5 nm, and 263 nm: equally spaced) in the spectrum of the 6 mM Phe solution are almost leveled out in the spectrum of the 1:1 Phe-S-1-PEA equimolar solution. This leveling out of vibrational structure can also be seen in all the spectra recorded of S-1-PEA, an indication that aromatic π-system interactions are present. Comparing the spectra of the solutions containing only Phe with those of only S-1-PEA, it is inferred that π-system interaction, if any, is much weaker between Phe molecules than S-1-PEA molecules.

A careful examination of the spectrum of the 1:1 equimolar solution of these two species indicates that the aromatic π-system interaction favors molecular transitions occurring in the wavelength region ranging from about 228 nm to 234 nm because both an increase in absorbance and shifts to longer wavelengths are recorded. These inferences are based on the fact that the sum of the absorbance values, for example, at 228 and 234 nm of the 3 mM solutions of Phe and S-1-PEA (228 nm: 0.17+0.31=0.48 and 234 nm: 0.13+0.16=0.29), as well as the separate absorbance values of the 6 mM solutions of Phe (228 nm: 0.265 and 234 nm: 0.236) and S-1-PEA (228 nm: 0.62 and 234 nm: 0.301), are lower than those of the equimolar solution (228 nm: 0.66 and 234 nm: 0.31) by margins greater than the instrumental error of absorbance (±0.005). The shift to a longer wavelength, for example, noted at 234 nm, in the spectrum of the 1:1 equimolar solution of Phe and S-1-PEA, is noticeable by visually inspecting the lowest absorbance values of the valleys (wavelength region 228 nm to 236 nm) of the spectra of these solutions. It is therefore clear that the interaction resulted in the formation of a Phe-S-1-PEA species with spectral properties that are different from either of its components.

Unlike Ala and Phe, the interaction experiment involving tyrosine resulted in the most dramatic changes in spectra. The spectral results are shown in FIG. 2. Strong bathochromic and hyperchromic effects can be seen in the spectral region ranging from about 240 nm to 260 nm of the 1:1 equimolar (2.5 mM) tyrosine-S-1-PEA solution compared to the spectrum of the 2 mM solution containing only tyrosine (Tyr). In addition a strong hyperchromic effect is recorded in the region 290 nm to 313 nm. Compared to Ala and Phe, tyrosine has a phenolic side chain, which is absent in both Ala and Phe. The hydroxyl group of the phenolic side chain can function as a strong hydrogen-bonding donor due to the electron withdrawing character of the phenyl group. Since it is the only group absent in phenylalanine, the dramatic spectral changes observed for the tyrosine-S-1-PEA system could be as a result of interaction through the hydroxyl group of the phenolic side chain.

To verify this, an interaction experiment, monitored using UV spectroscopy, was conducted between phenol and S-1-PEA in an aqueous medium. The spectral results of this experiment are shown in FIG. 27. A comparison of the spectrum of the 1:1 equimolar (2 mM) solution of phenol and S-1-PEA with that of 2.5 mM Tyr-S-1-PEA, shown in FIG. 2, unambiguously confirms the hydroxyl group of the phenolic side chain of Tyr as the point of interaction with S-1-PEA. As mentioned earlier, the hydroxyl group will act as a strong hydrogen-bonding donor. The amine group of S-1-PEA on the other hand, will act as a good hydrogen-bonding acceptor due to the electron donating effect of the alkyl group to which it is bonded. A strong hydrogen bonding interaction is therefore consided to be the mode of interaction accounting for the dramatic spectral changes observed betweem tyrosine and S-1-PEA.

Complete protonation of S-1-PEA by Tyr, which leads to ion pair interaction, is ruled out as a possible mode of interaction. This is because acidifying a 1:1 equimolar solution of Tyr and S-1-PEA with HCl, to protonate the amine group of S-1-PEA, leads to the complete disappearance of the bathochromic and hyperchromic effects. This is shown in FIG. 3. Formation of a hydrogen bond through the phenolic group by Tyr with S-1-PEA would allow the delocalization of lone pair electrons, from the nitrogen of the S-1-PEA and oxygen of the phenolic group of the tyrosine, over the hydrogen bond system. In addition, the π-system of the phenyl group of S-1-PEA can participate in the hydrogen bonding through hyperconjugation extended to the nitrogen. With the oxygen of Tyr involved in the hydrogen bonding, and directly connected to aromatic π-system of the phenyl group of Tyr, the aromatic π-system of Tyr should also participate in the hydrogen bonding system. As a result, it is expected that the aromatic π-systems would interact with each other through the lone pair electrons. These interactions would lower the π→π* transition energies. The dramatic spectral change observed in the region, 240 nm to 260 nm, is therefore attributed to the lowering of the energy of the symmetry forbidden, second primary band, π→π* transition (originally ˜220-223 nm: see FIG. 27) of the phenyl group of S-1-PEA, which causes it to be blue shifted. As a result, it overlaps with the symmetry forbidden, second primary band, π→π* transition, of the phenolic group (originally ˜219-225 nm: see spectrum of phenol in FIG. 28) of Tyr, which is bathochromically shifted due to the lowering of the π→π* transition energy through the hydrogen bonding system. FIG. 2 shows that the bathochromic and hyperchromic effects, in the region from 240 to 260 nm, are most pronounced in the spectrum of the 1:1 equimolar solution of Tyr and S-1-PEA compared to the other ratios. This indicates that the interaction is stoichiometric, or that it shows group specific interaction.

The spectra of the separate solutions of Tyr and phenol, compared to their 1:1 equimolar solutions with S-1-PEA, show slight shoulders in the region 290 to 313 nm of both spectra. This indicates they have undergone hyperchromic changes in the spectra of the respective 1:1 equimolar solutions (see FIGS. 2 and 27). This shoulder, found in the spectrum of the solution containing only Tyr, can only be due to the presence of the phenolic group since it is completely absent in the spectra of Phe and Ala, which do not have phenolic functional groups. The hyperchromic nature of the change observed in this shoulder is an indication of a favorable interaction of S-1-PEA with the phenolic group of Tyr. On the basis of our experimental analyses, this can happen only through hydrogen bonding interaction with S-1-PEA as described since other options like ion pair, benzene ring-benzene ring interactions are experimentally ruled out. From the combined results of the interaction experiments conducted using phenol and tyrosine compared to those of Ala and Phe it is clear that: (1) the phenolic group of Tyr is the point of interaction of Tyr with S-1-PEA, (2) hydrogen bonding is the predominant mode of interaction between Tyr and S-1-PEA, and (3) the interaction led to the formation a Tyr-S-1-PEA species whose spectral properties are significantly different from that of either of its components.

It has been observed that in the use of (S)-(+)-1-phenylethylamine, the predominant mode of interaction and the extent of its effect on UV spectra is dependent on the particular analyte involved. It can be seen from FIGS. 1, 7, 10 and 17 that the use of this chiral selector or resolving agent resulted, in each case, in a distinct diffrence between the spectra of the enantiomeric pair of the given analyte. This empirical observation shows that the chiral selector or resolving agent interacts differently with each enantiomer of a pair. This interaction, through the specific predominant mode of interaction leads to the formation a pair of diastereomeric species with different UV absorption properties. As a result, it is possible to carry out enantiomeric composition analysis via S-1-PEA diastereomerization discrimination using UV spectroscopy combined with multivariate chemometric analysis.

### Example 10

### Nature of Interactions Between (S)-(+)-1,2-Propanediol and Chiral Analyte

As mentioned earlier, the basis of enantiomeric discrimination for enantiomeric composition and enantiomeric excess determination using this chiral selector is the formation of diastereomeric pairs of esters. This is done with chiral analytes having carboxylic acid functional groups like the amino acids analyzed. The interaction of this chiral selector with the appropriate chiral analyte is strictly electron sharing through covalent bond formation. The electron sharing interaction through covalent bonding may lead to the formation of mono- or di-esters or a mixture of these products. Under the experimental conditions employed (see procedure described above), thermodynamic and/or kinetic factors may cause the preferential formation of an ester of one enantiomer over the other of a pair. However, both the type of ester formed, mono, di, or mixture, and the preferencial influence of thermodynamic and/or kinetic factors, have no adverse effect whatsoever on the discrimination. As a matter of fact, the thermodynamic and/or kinetic factors may play to the advantage of the enantiomeric composition and enantiomeric excess analysis. This is because their influence can quantitatively enhance the spectral difference between enantiomers, which will in turn improve correlation of spectral data with enantiomeric composition.

As mentioned earlier, the electron sharing interaction of this chiral selector, with appropriate chiral analytes, leads to the formation of covalent diastereomeric pairs of esters. As can be seen in FIG. 13, the spectrum of the L-enantiomer of Phe differs from that of the D-enantiomer in the wavelength region, 226 nm to 235 nm. This is a reflection of the difference in UV absorptivity as a result of difference in stereochemical structure. Like in the case of R/S-1-PEA, this kind of spectral difference permits the conducting of enantiomeric composition analysis via R/S-1,2-PD covalent diastereomerization discrimination using UV spectroscopy combined with multivariate chemometric analysis.

### REFERENCES CITED

The entire content of each of the following documents is hereby incorporated by reference.

### U.S. Patent Documents

U.S. Pat. No. 7,191,070
U.S. patent application Ser. No. 11/664,079
U.S. Provisional Patent Application No. 60/724,861

### Other Publications

Balabai, J. Phys. Chem., vol. 102, p. 9617, 1998
Bortolus, et al., J. Phys. Chem. A, vol. 106, p. 1686, 2002
Burley, et al., Science (Washington, D.C.) vol. 229(4708), pp. 23-28, 1985
Cox, et al., J. Photochem. Photobiol., vol. 39, p. 597, 1984
Otagiri, et al., Chem. Pharm. Bull., vol. 23, p. 188, 1975
Park, et al., J. Phys. Chem., vol. 98, p. 6158, 1994
Schiller, et al., J. Chem. Soc., Faraday Trans., vol. 83, p. 3227, 1987
Suzuki, Electronic Absorption Spectra and Geometry of Organic Molecules, p. 102, 1967

What is claimed is:

1. A method for determining an unknown enantiomeric composition of a chiral compound in an unknown sample, comprising:
preparing a series of known samples, each of the known samples comprising a first complex, wherein, the first complex in each of the known samples comprises a ratio of a host compound and the chiral compound having a known enantiomeric composition,
wherein, in each of the known samples, the ratio of the chiral compound to the host compound remains the same and the enantiomeric composition of the chiral compound is varied, wherein, in each of the known samples, the concentrations of the chiral compound and of the host compound are at a preset level, wherein the host compound interacts with the chiral compound through ion pair formation, and wherein the host compound is phenylethylamine, 1,2-propanediol, naphthylethylamine, or 2-butanol;
collecting absorption spectral data of the known samples at various wavelengths;
performing a principal component analysis to select a spectral range of wavelengths in which the spectral differences arising in each of the known samples due to an influence of the enantiomeric composition is most appreciable to give the selected range of wavelengths;
performing a partial-least-squares regression of the spectral data over the selected range of wavelengths for each of the series of the known samples to determine a series of regression coefficients and a regression constant;
entering the series of regression coefficients for the selected range of wavelengths into a regression vector;
collecting absorption spectral data of the unknown sample at the selected range of wavelengths to give unknown spectral data, wherein the unknown sample comprises a second complex having the same ratio of the chiral compound to the host compound as that of the first complex in each of the known samples, and wherein, in the unknown sample, the concentrations of the chiral compound and of the host compound are at the preset level; and
inserting the unknown spectral data into the regression vector to allow calculation of the unknown enantiomeric composition of the chiral compound in the unknown sample.

2. The method of claim 1, wherein the regression vector is:
X_{R}=k₀+k₁A₁+k₂A₂+ . . . +kₙAₙ,
and wherein:
X_{R} is the unknown enantiomeric composition of the chiral compound in the unknown sample,
kᵢ is the series of regression coefficients calculated for each of the wavelengths in the selected range of wavelengths,
Aᵢ is the absorption spectral data of the unknown compound at each of the wavelengths in the selected range of wavelengths,
i is the selected range of wavelengths, 1−n, and
k₀ is the regression constant.

3. (canceled)

4. (canceled)

5. (canceled)

6. (canceled)

7. The method of claim 1, wherein the chiral compound is selected from the group consisting of alanine, phenylalanine, and tyrosine.

8. A method for determining an unknown enantiomeric composition of a chiral compound in an unknown sample, comprising:
preparing a series of known samples, each of the known samples comprising a first complex, wherein, the first complex in each of the known samples comprises a ratio of phenylethylamine and the chiral compound having a known enantiomeric composition,
wherein, in each of the known samples, the ratio of the chiral compound to phenylethylamine remains the same and the enantiomeric composition of the chiral compound is varied, and wherein, in each of the known samples, the concentrations of the chiral compound and of phenylethylamine are at a preset level;
collecting absorption spectral data of the known samples at various wavelengths;
performing a principal component analysis to select a spectral range of wavelengths in which the spectral differences arising in each of the known samples due to an influence of the enantiomeric composition is most appreciable to give the selected range of wavelengths;
performing a partial-least-squares regression of the spectral data over the selected range of wavelengths for each of the series of the known samples to determine a series of regression coefficients and a regression constant;
entering the series of regression coefficients for the selected range of wavelengths into a regression vector;
collecting absorption spectral data of the unknown sample at the selected range of wavelengths to give unknown spectral data, wherein the unknown sample comprises a second complex having the same ratio of the chiral compound to phenylethylamine as that of the first complex in each of the known samples, and wherein, in the unknown sample, the concentrations of the chiral compound and of phenylethylamine are at the preset level; and
inserting the unknown spectral data into the regression vector to allow calculation of the unknown enantiomeric composition of the chiral compound in the unknown sample.

9. The method of claim 9, wherein the chiral compound is selected from the group consisting of alanine, phenylalanine, and tyrosine.

10. A method for determining an unknown enantiomeric composition of a chiral compound in an unknown sample, comprising:
preparing a series of known samples, each of the known samples comprising a first complex, wherein, the first complex in each of the known samples comprises a ratio of 1,2-propanediol and the chiral compound having a known enantiomeric composition,
wherein, in each of the known samples, the ratio of the chiral compound to 1,2-propanediol remains the same and the enantiomeric composition of the chiral compound is varied, and wherein, in each of the known samples, the concentrations of the chiral compound and of 1,2-propanediol are at a preset level;
collecting absorption spectral data of the known samples at various wavelengths;
performing a principal component analysis to select a spectral range of wavelengths in which the spectral differences arising in each of the known samples due to an influence of the enantiomeric composition is most appreciable to give the selected range of wavelengths;
performing a partial-least-squares regression of the spectral data over the selected range of wavelengths for each of the series of the known samples to determine a series of regression coefficients and a regression constant;
entering the series of regression coefficients for the selected range of wavelengths into a regression vector;
collecting absorption spectral data of the unknown sample at the selected range of wavelengths to give unknown spectral data, wherein the unknown sample comprises a second complex having the same ratio of the chiral compound to 1,2-propanediol as that of the first complex in each of the known samples, and wherein, in the unknown sample, the concentrations of the chiral compound and of 1,2-propanediol are at the preset level; and
inserting the unknown spectral data into the regression vector to allow calculation of the unknown enantiomeric composition of the chiral compound in the unknown sample.

11. The method of claim 11, wherein the chiral compound is selected from the group consisting of alanine, phenylalanine, and tyrosine.
